(19) United States
(12) Patent Application Publication
(10) Pub. No.: US 2009/0161500 A1
(43) Pub. Date: Jun. 25, 2009

(54) STORAGE APPARATUS AND METHOD FOR STORING DATA

(75) Inventor: Masataka Moteki, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/204,726

(22) Filed: Sep. 4, 2008

(30) Foreign Application Priority Data
Dec. 22, 2007 (JP) 2007-331199

(51) Int. Cl. G11B 19/00

(52) U.S. Cl. 369/24.01; G9B/19

(57) ABSTRACT

A storage apparatus includes: a storage device that stores data on a storage medium being configured with a storage area on which the data having a plurality of partial areas is repetitively overwritten; and a management unit that operates to: generate management information for managing the data based on a name assigned to the partial area, boundary information representing a boundary between the partial areas, and time information representing time on which each of the partial areas are stored; store the management information in the storage device; and set, as a name of the data, the name of one of the partial areas having the oldest time based on the management information.

### CROSS-REFERENCE TO RELATED APPLICATIONS

This application is based upon and claims the benefit of priority from Japanese Patent Application No. 2007-331199, filed on Dec. 22, 2007, the entire content of which are incorporated herein by reference.

### BACKGROUND

1. Field

One embodiment of the present invention relates to a storage apparatus and a method for storing data while ensuring consistency of contents of recorded data stored in a loop is recording area with a name of the contents.

2. Description of the Related Art

In a video recording apparatus utilizing a mass storage medium, such as a hard disk, there has been developed a recording method that is referred to as a loop recording. The loop recording is a recording method for maintaining a predetermined area separately from a normal recording area and repeating overwrite recording independently of the normal recording in the predetermined area. The loop recording has a limited recording capacity but can perform recording which allows a user not to mind a residual capacity of the storage medium. Therefore, for example, it is possible to implement a usage of temporarily retaining a program which is stopped being viewed in the middle of the program for allowing the user to restart viewing the program from the stopped position.

Conventionally, there has been known a recording apparatus and a method which can comprehensively manage recording data stored in the loop recording area and recording data stored in the normal recording area. An example of such apparatus and method is disclosed in JP-A-2007-172794 (counterpart U.S. publication is: US 2007/0147780 A1).

In the loop recording, recording in the loop recording area for loop recording is started when the loop recording is started in accordance with a user's operation, and subsequent recording is continuously performed by returning to a start point of the loop recording area when the recording proceeds to an end point of the loop recording area. Since thus overwritten, data recorded in the loop recording area cannot be permanently stored. According to the recording apparatus and method described in JP-A-2007-172794, however, the loop recording area can be managed in the same manner as the normal recording area and is set to be a recorded area using the data subjected to the loop recording as data for storage when the loop recording is ended. Therefore, the data subjected to the loop recording can be recorded, in a mass storage medium, as data which is not overwritten.

According to the conventional recording apparatus and method, however, when the loop recording is performed over a plurality of programs and the recorded data is overwritten, a name of contents that is set in accordance with a program name of data firstly recorded first is not configured to be overwritten. For this reason, there is a problem in that it is impossible to ensure a consistency of contents of the recorded data retained in the loop recording area with the name of the contents.

### SUMMARY

According to a first aspect of the present invention, there is provided a storage apparatus including: a storage device that stores data on a storage medium being configured with a storage area on which the data having a plurality of partial areas is repetitively overwritten; and a management unit that operates to: generate management information for managing the data based on a name assigned to the partial area, boundary information representing a boundary between the partial areas, and time information representing time on which each of the partial areas are stored; store the management information in the storage device; and set, as a name of the data, the name of one of the partial areas having the oldest time based on the management information.

According to a second aspect of the present invention, there is provided a storage apparatus including: a storage device that stores data on a storage medium being configured with a storage area on which the data having a plurality of partial areas is repetitively overwritten; and a management unit that operates to: generate management information for managing the data based on a name assigned to the partial area, boundary information representing a boundary between the partial areas, and time information representing time on which each of the partial areas are stored; store the management information in the storage device; and set, as a name of the data, the name of one of the partial areas having the newest time based on the management information.

According to a third aspect of the present invention, there is provided a storage apparatus including: a storage device that stores data on a storage medium being configured with a storage area on which the data having a plurality of partial areas is repetitively overwritten; and a management unit that operates to: generate management information for managing the data based on a name assigned to the partial area, boundary information representing a boundary between the partial areas, and time information representing time on which each of the partial areas are stored; store the management information in the storage device; and set, as a name of the data, the name of one of the partial areas having the longest time based on the management information.

According to a fourth aspect of the present invention, there is provided a method for storing data, the method including: storing the data on a storage medium being configured with a storage area on which the data having a plurality of partial areas is repetitively overwritten; generating management information for managing the data based on a name assigned to the partial area, boundary information representing a boundary between the partial areas, and time information representing time on which each of the partial areas are stored; storing the management information in the storage device; and setting, as a name of the data, the name of one of the partial areas having the oldest time based on the management information.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate an embodiment of the invention and not to limit the scope of the invention.

FIG. 1 is a block diagram showing a configuration of a television system having a recording apparatus according to a first embodiment of the present invention.

FIG. 2 is a diagram showing a data structure in the recording apparatus according to the first embodiment.

FIG. 3 is an enlarged diagram showing a part of management information according to the first embodiment.

FIG. 4 is a block diagram showing a configuration of a record processing control unit according to the first embodiment.

FIG. 5 is a diagram showing an example of usage of a plurality of AV stream files according to the first embodiment.

FIG. 6A is a diagram showing a state in which a loop recording operation is started according to the first embodiment.

FIG. 6B is a diagram showing a state in which the loop recording operation progresses according to the first embodiment.

FIG. 6C is a diagram showing the state in which the loop recording operation progresses according to the first embodiment.

FIG. 6D is a diagram showing the state in which the loop recording operation progresses according to the first embodiment.

FIG. 7 is a flowchart according to the first embodiment.

FIG. 8A is a diagram showing a state in which a loop recording operation is started according to a second embodiment of the present invention.

FIG. 8B is a diagram showing a state in which the loop recording operation progresses according to the second embodiment.

FIG. 8C is a diagram showing the state in which the loop recording operation progresses according to the second embodiment.

FIG. 8D is a diagram showing the state in which the loop recording operation progresses according to the second embodiment.

FIG. 9 is a flowchart according to the second embodiment.

FIG. 10A is a diagram showing a state in which a loop recording operation is started according to a third embodiment of the present invention.

FIG. 10B is a diagram showing a state in which the loop recording operation progresses according to the third embodiment.

FIG. 10C is a diagram showing the state in which the loop recording operation progresses according to the third embodiment.

FIG. 10D is a diagram showing the state in which the loop recording operation progresses according to the third embodiment.

FIG. 11 is a flowchart according to the third embodiment.

FIG. 12 is a flowchart according to the third embodiment.

FIG. 13 is a flowchart according to the third embodiment.

FIG. 14A is a diagram showing a state in which a loop recording operation is started according to a first modification.

FIG. 14B is a diagram showing a state in which the loop recording operation progresses according to the first modification.

FIG. 14C is a diagram showing a state in which the loop recording operation progresses according to the first modification.

FIG. 14D is a diagram showing a state in which the loop recording operation progresses according to the first modification.

FIG. 15 is a flowchart according to a second modification.

FIG. 16 is a flowchart according to the second modification.

FIG. 17 is a flowchart according to the second modification.

### DETAILED DESCRIPTION

Embodiments of the present invention will be described with reference to the accompanying drawings.

In a video recorder (a recording apparatus) or a television which is provided with a function that is so-called a loop recording function, an operation for starting loop recording can be performed for temporary interrupting viewing a broadcast program in a case such as when a user leaves a room, and a reproduction can be performed from a position in which the viewing is interrupted by a starting operation such as “a follow-up reproducing operation” when the user restarts viewing the broadcast program.

On the other hand, it is also possible to configure a recording apparatus so as to automatically perform the loop recording without the user's intentional operation to start the loop recording. According to the configuration, for example, in a case in which a video recorder is built in a television, the loop recording is automatically started when the television is turned ON. In this case, for example, it is possible to implement a usage of displaying a scene of a position obtained by playing back from a scene which is being viewed slightly on a time basis again, thereby reconfirming the contents in a program to which attention is paid or an address for a lottery application.

Moreover, it is also possible to propose an expansion into the following recording function in addition to a simple usage of performing a reproduction and viewing.

In many cases, the user sets a programmed recording by previously learning the contents of a program. However, there is also a case in which the user starts the recording operation while a television program is viewed to know the contents. In such case, the recording operation is started in the middle of the broadcast of the television program which is being viewed, and it is naturally proposed that a position before the execution of the recording start operation for the television program can be stored for convenience. In this case, by not only recording the program after a position where the user inputs the recording start operation but also automatically recording a part before the position in advance without the user's notice, the broadcast program that is viewed can be recorded retroactively before the recording start operation is input. In accordance with the configuration, a broadcast program that is start recorded in the middle can also be entirely recorded from a beginning of the broadcast program.

As a matter of course, it is not necessary to leave a program which is being simply viewed by the user without a consciousness of the storage. For this reason, a record processing to be automatically performed without a special consciousness of the user takes a loop recording configuration in which a position corresponding to a certain time is held and a past portion is cancelled.

In the case in which the loop recording operation is continuously performed for a long time, therefore, there is a possibility that a program recorded at the start of the loop recording operation might be deleted and might not be present sooner or later. In other words, contents corresponding to a program name set to be a name of contents to be recorded at the start of the loop recording operation are not finally present at the end of the loop recording operation. Consequently, there is a problem in that a consistency of the name of the contents with the contents cannot be taken.

The present invention provides a suitable storage apparatus and method for ensuring a consistency of a name of contents stored in a loop recording area with the contents.

### First Embodiment

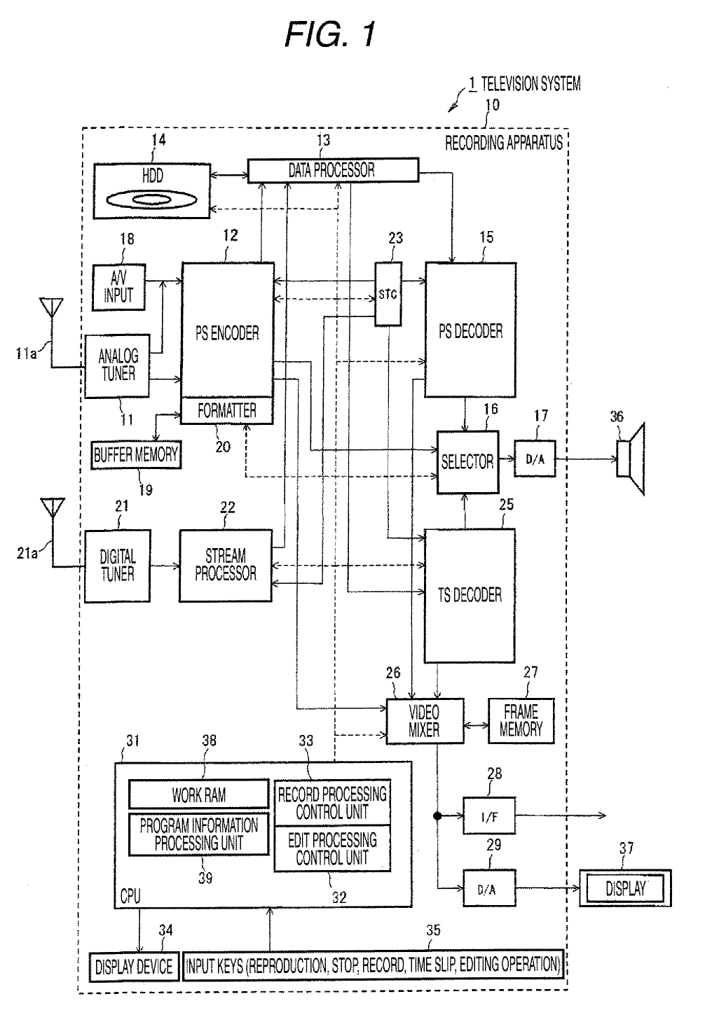

A first embodiment of a storage apparatus according to the invention will be described below in detail with reference to the drawings. FIG. 1 is a block diagram showing a configuration of a television system using the storage apparatus according to the first embodiment of the present invention.

As shown in FIG. 1, a recording apparatus 10 configures a television system 1 together with a speaker 36, a display 37, an analog antenna 11a for receiving terrestrial analog broadcasting, and a digital antenna 21a for receiving terrestrial digital broadcasting.

The recording apparatus 10 includes an analog tuner 11, a PS encoder 12, a data processor 13, an HDD (Hard Disk Drive) 14, a PS decoder 15, a selector 16, a D/A converter 17, an AV (Audiovisual) input terminal 18, a buffer memory 19, a formatter 20, a digital tuner 21, a stream processor 22, an STC (System Time Clock) 23, a TS decoder 25, a video mixer 26, a frame memory 27, an I/F 28, a D/A converter 29, a CPU (Central Processing Unit) 31 having an edit processing control unit 32 and a record processing control unit 33, a display device 34, and an input keys 35.

The analog tuner 11 is an analog tuner for receiving an analog broadcast wave broadcast by a ground wave through the analog antenna 11a. The analog tuner 11 tunes and demodulates a broadcast wave based on a predetermined broadcast system such as NTSC and converts the broadcast wave into analog video and audio signals, and outputs them to the PS encoder 12.

The PS encoder 12 is an encoder including an A/D converter for digitalizing an analog video signal and an analog audio signal which are input, a video encoder and an audio encoder, and may include a subvideo encoder. The PS encoder 12 converts the digitalized video signal into a compression digital video signal having a variable bit rate based on MPEG2 or MPEG1 standards. Moreover, the PS encoder 12 converts the digitalized audio signal into a compression digital audio signal having a fixed bit rate based on MPEG or AC-3 standards or a linear PCM digital audio signal. When the analog video signal or the analog audio signal is input from the analog tuner 11, the PS encoder 12 performs a predetermined encode processing. More specifically, the PS encoder 12 converts the video signal and the audio signal into the digital signals and then encodes them, and performs packing into a video pack, an audio pack and a subvideo pack, and furthermore, combines them and converts them into a suitable format for recording in the HDD 14. The signal converted by the PS encoder 12 is transmitted to the data processor 13. The PS encoder 12 may directly transfer data to the selector 16 without encoding the digital video or audio signal which is subjected to the A/D conversion.

The data processor 13 is a data processing unit for receiving the digital video and audio signals which are encoded by the PS encoder 12 and writing the received signals to the HDD 14 in a subsequent stage. More specifically, the data processor 13 receives data on a GOP (Group of Picture) unit from the formatter 20 provided in the PS encoder 12 when recording contents of analog broadcasting and from the stream processor 22 when recording contents of digital broadcasting respectively, and records them in the HDD 14. In addition, the data processor 13 also has the function of reading a predetermined reproducing signal from the HDD 14. The data processor 13 includes a buffer circuit, a modulating and demodulating circuit, and an error correcting circuit, and executes a data processing on a recording or reproducing unit.

The HDD 14 is a storage device for driving a storage medium such as a hard disk to record and reproduce data. The HDD 14 is not limited to the hard disk drive but may be any storage device that can record and reproduce digital data.

The PS decoder 15 is a decoder including a separator for separating and fetching the video and audio packs from a multiple signal recorded with a pack configuration in the HDD 14, a memory to be used for executing the pack separation and the other signal processing, a video decoder for decoding main video data (contents of the video packs) separated through the separator, a subpicture decoder for decoding subvideo data (contents of the subvideo pack) separated through the separator, and an audio decoder for decoding audio data (contents of the audio pack) separated through the separator. The PS decoder 15 may include a video processor for properly synthesizing a subvideo decoded into a main video which is decoded and superposing a menu, a highlight button, a caption and other subvideos on the main video and outputting them. The PS decoder 15 basically decodes a video/audio signal of an analog broadcast wave which is A/D converted and recorded in the HDD 14.

The selector 16 is a signal switch for selecting a signal output from the PS decoder 15, a signal output from the is TS decoder 25, a signal output from the PS encoder 12 and a signal output from the stream processor 22 and outputting them to the D/A converter 17. More specifically, the selector 16 selects any of an analog broadcast wave signal recorded in the HDD 14 and a digital broadcast wave signal recorded thereon, an analog broadcast wave signal which is digitalized by the PS encoder 12, and a digital broadcast wave signal sent from the stream processor 22. The selector 16 executes the selection based on a select signal sent from the CPU 31.

The D/A converter 17 is a converter for converting the digital video and audio signals selected by the selector 16 into analog video and audio signals. The D/A converter 17 outputs, to the speaker 36, the audio signal which is converted into analog signal.

The digital tuner 21 is a digital tuner for receiving a ground wave and a digital broadcast wave such as BS (Broadcasting Satellite) or CS (Communication Satellite) through the digital antenna 21a corresponding to the analog tuner 11. The digital tuner 21 extracts a TS packet for a video or an audio of a program selected by a user from an MPEG2-TS signal and inputs the TS packet to the stream processor 22.

The stream processor 22 is a data converter for performing a conversion processing of processing video data or audio data divided into small TS packets extracted by the digital tuner 21 into packets having large sizes which are suitable for recording in the HDD 14. The information thus converted is recorded in the HDD 14 through the data processor 13.

The TS decoder 25 is a decoder for decoding a recording signal of a digital broadcast wave which is read from the HDD 14 through the data processor 13 corresponding to the PS decoder 15. The TS decoder 25 includes a separator for separating and fetching a video and an audio from a multiple signal which is recorded, a video decoder for decoding video data thus separated, and an audio decoder for decoding the audio data which are separated in the same manner. The TS decoder 25 inputs the decoded digital video and audio signals to the selector 16 and the video mixer 26.

The CPU 31 executes processing such as a detection of a defective place, a detection of an unrecorded area, setting of a picture recording information recording position, UDF (Universal Disk Format) recording and AV address setting in accordance with a control program. Moreover, the CPU 31 has a necessary information processing portion for controlling a whole system and includes a work RAM (Random Access Memory) 38, and a video management information generating portion, a copy related information detecting portion, a copy and scrambling information processing portion, a packet header processing portion, a sequence header processing portion and an aspect ratio information processing portion which are not shown. A timing in which the CPU 31 controls the PS encoder 12, the data processor 13, the HDD 14 and the stream processor 22 is based on time data managed by the STC 23. The recording and reproducing operations are performed synchronously with a time clock sent from the STC 23, and the other processing may be performed in an independent timing.

Moreover, the CPU 31 also includes an edit processing control unit 32 for controlling management information when executing an edit and a record processing control unit 33 for controlling management information when executing the recording operation. Furthermore, the CPU 31 generates necessary management information for reproducing the recorded data and transfers, to the data processor 13, the management information created at the end of the data recording operation. Consequently, the management information is recorded in the HDD 14. Accordingly, the CPU 31 receives information on a data unit (divided information) from the PS encoder 12 when encoding is performed and from the stream processor 22 when the MPEG2-TS signal is recorded. The CPU 31 has the function of recognizing management information about a file system which is read from the HDD 14, recognizing an unrecorded area of the HDD 14 and setting a data recording area into the HDD 14 through the data processor 13 at the start of the recording operation.

The edit processing control unit 32 is a management data processing unit for editing a management information corresponding to video and audio signals recorded in the HDD 14.

The record processing control unit 33 is a management data processing unit for controlling the operation for recording the video and audio signals in the HDD 14 and setting the management information.

The display device 34 is a display device for indicating an operation situation in the CPU 31 to a user and is configured by an LCD (Liquid Crystal Display) device, for example. The input keys 35 are an input device for inputting an instruction of the user to the CPU 31, for example, a keyboard or a remote controller.

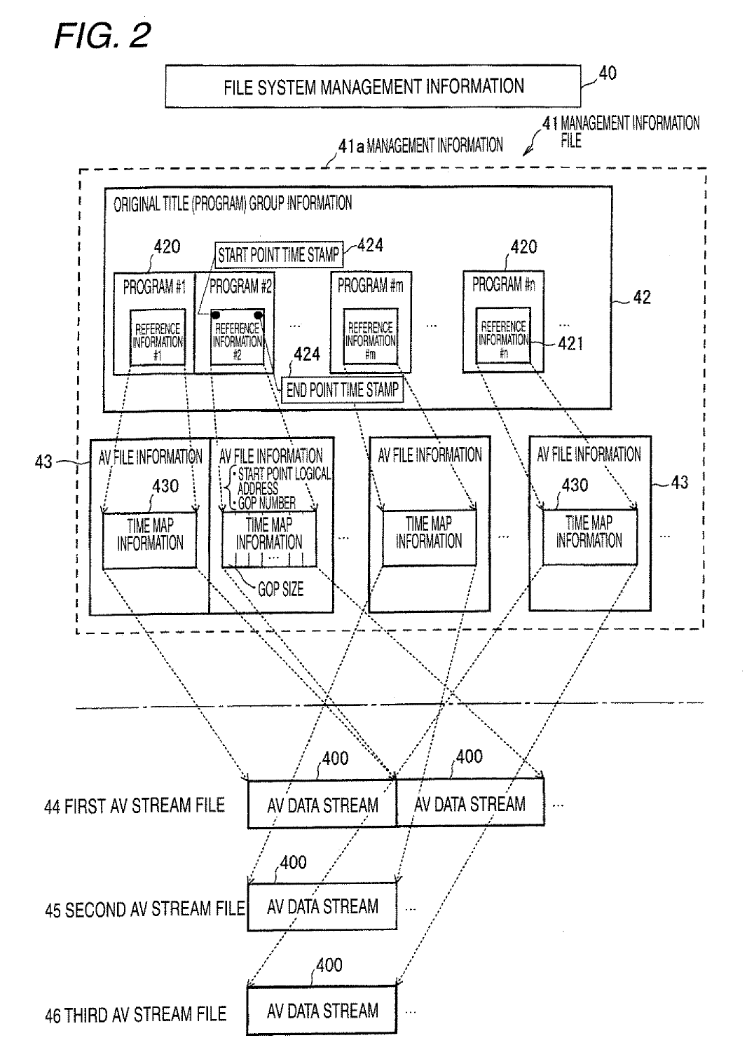

FIG. 2 is a diagram showing a data structure in the recording apparatus according to the first embodiment of the invention. As shown in FIG. 2, data recorded in the recording apparatus 10 includes a file system management information 40, a management information file 41, a management information 41a, a first AV stream file 44, a second AV stream file 45 and a third AV stream file 46 which are recorded in the HDD 14 respectively as an example. A program group information 42 (an original title group information) for managing a reproducing order of recorded contents is defined in the management information file 41.

The management information 41a serves to manage a position information and an attribute for data to be recorded in the HDD 14. The management information 41a has the program group information 42 and AV file information 43.

As shown in FIG. 2, the program group information 42 is information (reproducing order information) for managing a reproducing order of recorded contents (programs) and a program information 420 about individual programs is arranged on a program unit. The individual program information 420 has reference information 421 linked to the AV file information 43 which is an information about an AV data stream (an aggregate of video and audio data on the program unit) to be a reproducing target.

The AV file information 43 is a table for connecting the program group information 42 to be a management target of a user to recorded data to be real recorded data. The AV file information 43 has time map information 430 on which a logical address information in the HDD 14 is described in the corresponding AV data stream 400.

Each of the first to third AV stream files 44 to 46 is a data file configured by the AV data stream 400 corresponding to each program (title: a unit on which a user performs one recording operation). The individual AV data streams 400 configuring the first to third AV stream files 44 to 46 are configured by an information pack, a video pack, an audio pack and a subvideo pack. The information pack is an information package for an attribute and identification of the AV data stream 400, and includes an information indicative of a start time that a first field of GOP to which the information package belongs is reproduced, an information indicative of the recording time of the corresponding GOP, and copy control information. The video pack is an information package in which video data are compressed by the MPEG2 method and is configured by a pack header, a packet header and a video data position. The audio pack is an information package in which audio data are processed by a linear PCM, MPEG or AC-3 method, for example, and is configured by a pack header, a packet header and an audio data position.

The first AV stream file 44 is a data file prepared for a normal picture recording and reproducing operation, for example, and the second AV stream file 45 to be first data is a data file prepared for a loop recording operation, for example, and the third AV stream file 46 is a data file prepared for a normal picture recording and reproducing operation, for example. The “normal recording” indicates a recording operation intended for a storage, and the “loop recording” indicates a recording operation in which an overwrite recording operation is repetitively performed in a predetermined recording area (storage area) in the HDD 14 to enable a storage for a certain time (for example, 60 minutes).

The file system management information 40 is based on the UDF standards, for example, and is a management information for managing the file of the management information 41a and the first to third AV stream files 44 to 46.

In addition to the program group information 42, it is also possible to provide play list information configured by only information (reproducing order information) for managing the reproducing order of a program. The play list information does not possess its own AV data stream 400 but is generated by editing (deleting and adding) the reference information 421 linked to the AV file information 43 of the original title. More specifically, by editing only the reference information 421 without directly processing the AV data stream 400, it is possible to generate a program configured by only a necessary scene or to generate a program from which an unnecessary scene is removed.

While the description has been given to the example in which three AV stream files, that is, the first to third AV stream files 44 to 46 are present in FIG. 2, at least four AV stream files may be present.

Furthermore, only one AV stream file may be present. When one AV stream file is present, the individual AV data streams 400 are recorded in a single AV stream file on recording media. A relationship between the program group information 42 of the management information 41a and the AV file information 43 and a relationship between the AV file information 43 and the AV data stream 400 are the same as those in FIG. 2 described above.

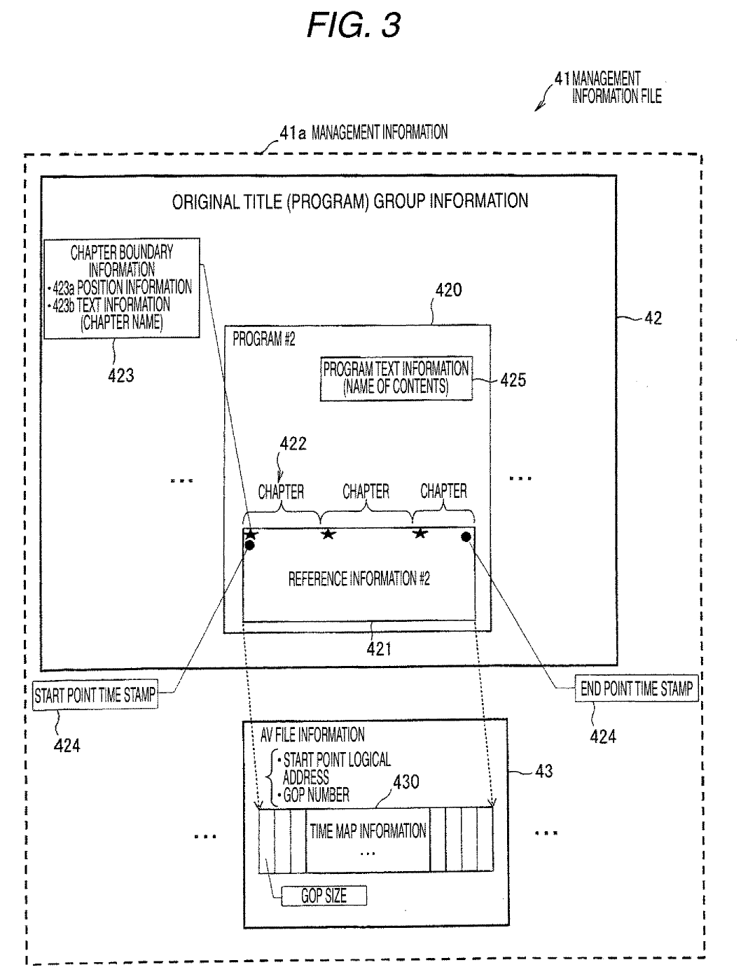

FIG. 3 is an enlarged diagram showing a part of the management information according to the first embodiment. A partial area in a program will be hereinafter referred to as a chapter 422.

As shown in FIG. 3, an information indicative of a boundary between the chapters 422 to be a partial area in a program is provided in the reference information 421 so that the program can be divided into the chapters 422. More specifically, a section interposed between two adjacent chapter boundary information 423 or a section between start or endpoints of the chapter boundary information 423 and the reference information 421 acts as the chapter 422. Strictly, the start point of the reference information 421 or a position in which the chapter boundary information 423 is set is used as the start point of the chapter 422, and a position placed immediately before a next chapter boundary or the end point of the reference information 421 is set to be the end point of the chapter 422. Accordingly, the chapter boundary information 423 is provided in a head position of the chapter 422.

The chapter boundary information 423 has position information 423a to be a boundary information in a partial area to which the chapter boundary information 423 is set (a time stamp 424 to be time information in a partial area on the reference information 421) and text information (a chapter name) 423b to be a name of the partial area. As described above, the chapter boundary information 423 is provided in the head position of the chapter 422. Therefore, the text information 423b set to the chapter boundary information 423 can be regarded to be a name of the chapter 422 setting, as a head, the position of the chapter boundary information 423.

The start point of the first chapter 422 in the program is coincident with that of the reference information 421. Therefore, it is sufficient that the chapter boundary information 423 is not always present in the head. In that case, however, it is necessary to exceptionally and separately prepare an area for retaining the text information 423b to be the name of the chapter 422. In order to unify the operation, therefore, the chapter boundary information 423 is also provided on the start point of the first chapter 422 in the example of FIG. 3.

On the other hand, there is employed a mechanism for providing an area for retaining a program text information (contents name) 425 to be a name for a program itself including the chapters 422 in an individual original title group information (a program group information) 42.

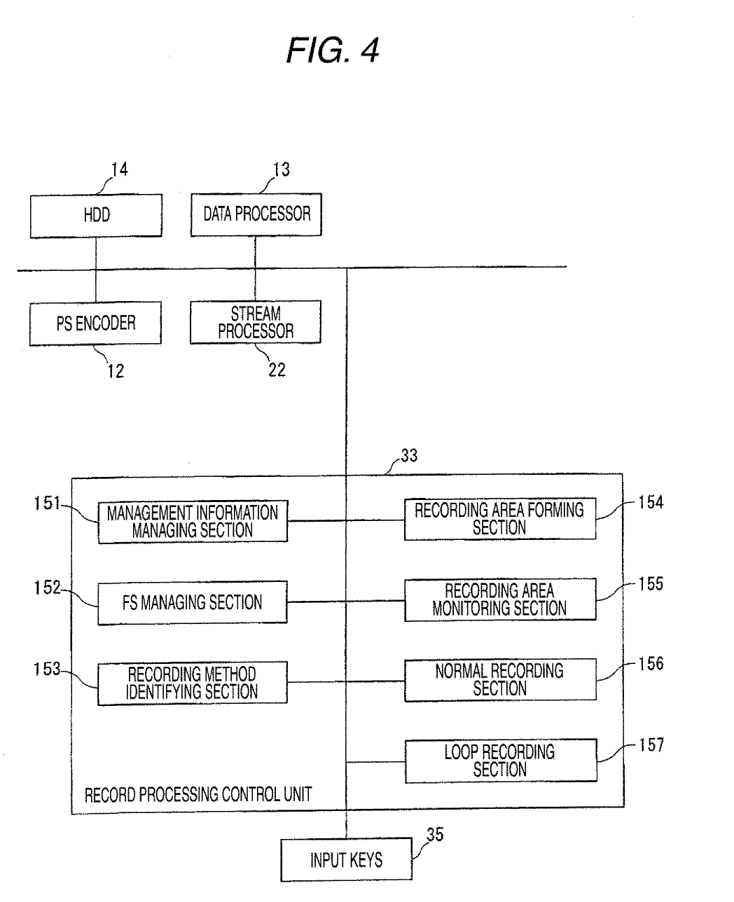

FIG. 4 is a block diagram showing a configuration of a record processing control unit according to the first embodiment. The record processing control unit 33 has the function of executing the record processing of the recording apparatus 10.

As shown in FIG. 4, the record processing control unit 33 has a management information managing section 151, an FS managing section 152, a recording method identifying section 153, a recording area forming section 154, a recording area monitoring section 155, a normal recording section 156 and a loop recording section 157. The recording apparatus 10 performs a recording operation with the data recording configuration shown in FIG. 2, that is, a configuration in which the AV stream file for a normal recording operation (for example, the first and third AV stream files 44 and 46) and an AV stream file for a loop recording operation (the second AV stream file 45) are configured separately from each other.

The management information managing section 151 serves as an information processing unit for managing the program group information 42 and the AV file information 43 shown in FIG. 2. The management information managing section 151 has the function of providing, to a user, the program group information 42 recorded in the HDD 14 through the display device 34 and the display 37 and setting the program group information 42 in the recording operation. The program group information 42 managed by the management information managing section 151 includes a time information for each program (a time information indicative of a position in the data recorded in the HDD 14). Moreover, the AV file information 43 managed by the management information managing section 151 includes a logical address information corresponding to a logical position information of the recorded data.

The FS managing section 152 serves as an information processing unit for managing the file system management information 40 based on the UDF standards, for example. In the recording apparatus 10, the recorded data for each program are connected to constitute an AV stream file. The FS management information is identification information of the AV stream file and the FS managing section 152 manages the AV stream file through the FS management information.

The recording method identifying section 153 serves as a recording method managing unit for identifying a recording method based on the contents of an instruction which is given from the user and is input through the input keys 35. The recording method managed by the recording method identifying section 153 includes two recording methods, that is, a normal recording method of performing a normal recording operation and a loop recording method of performing a recording operation while overwriting a predetermined recording area repetitively. The instruction given from the user may be assumed to be given from the user even if it is explicit or until a cancellation is performed.

The recording area forming section 154 serves as a managing unit for maintaining and managing the recording area of the HDD 14. The recording area forming section 154 has the function of previously maintaining or opening the recording areas of the first to third AV stream files 44 to 46 with respect to the HDD 14 as an example.

The recording area monitoring section 155 serves as a monitoring unit for monitoring the recording area prepared by the recording area forming section 154. The recording area monitoring section 155 has the function of monitoring the recording area prepared by the recording area forming section 154 and giving a notice of a result of the monitoring operation to the normal recording section 156 or the loop recording section 157.

The normal recording section 156 serves as a processing unit for executing the normal record processing and has the function of giving the data processor 13 an instruction for normally recording, in the HDD 14, the video data and the audio data which are transferred from the PS encoder 12 or the stream processor 22.

The loop recording section 157 serves as a processing unit for executing the loop record processing. The loop recording section 157 has the function of giving the data processor 13 an instruction for loop recording, in a predetermined recording area of the HDD 14, the video data and the audio data which are transferred from the PS encoder 12 or the stream processor 22.

The operation of the recording apparatus according to the first embodiment will be described below with reference to FIGS. 1 to 4 and FIGS. 5 to 7 which will be explained later.

In case of an analog broadcast signal, the analog tuner 11 receives an electric wave of an analog broadcast wave from the analog antenna 11a and tunes and demodulates the electric wave, and performs a conversion into analog video and audio signals and outputs them to the PS encoder 12. Upon receipt of the analog video and audio signals, the PS encoder 12 A/D converts the video and audio signals and performs packing (formatting) through the formatter 20, and outputs the signals to the data processor 13. At this time, the CPU 31 (the management information managing section 151) generates the management information 41a and transfers the management information 41a to the data processor 13. The data processor 13 records the received video and audio signals together with the management information 41a in the HDD 14.

On the other hand, the video and audio signals recorded in the HDD 14 are read from the data processor 13 and are transferred to the PS decoder 15. The PS decoder 15 separates and decodes packed signals of the read video and audio signals and outputs the signals thus obtained to the selector 16 and the video mixer 26. The selector 16 transmits the received signal to the D/A converter 17. The D/A converter 17 D/A converts the received digital audio signal and outputs the signal thus obtained to the speaker 36. Moreover, the video mixer 26 transmits the received signal to the D/A converter 29. The D/A converter 29 D/A converts the received digital video signal and outputs the signal thus obtained to the display 37.

In case of a digital broadcast signal, the digital tuner 21 receives an electric wave of a digital broadcast wave from the digital antenna 21a and tunes and demodulates the electric wave, and extracts digital video and audio signals. In case of digital broadcasting, a video and an audio are encoded on a broadcasting station side and is in the form of an MPEG2-TS signal. The stream processor 22 selects a necessary packet from the received MPEG2-TS signal, and converts a TS packet into a recording packet and transfers the recording packet to the data processor 13. The data processor 13 records the received data in the HDD 14.

The video and audio signals of the digital broadcast wave which are recorded in the HDD 14 are read from the data processor 13 and are transferred to the TS decoder 25. The TS decoder 25 separates and decodes packed signals of the read video and audio signals and outputs the signals thus obtained to the selector 16 and the video mixer 26. The selector 16 transmits the received signal to the D/A converter 17. The D/A converter 17 D/A converts the received digital audio signal and outputs the signal thus obtained to the speaker 36. Moreover, the video mixer 26 transmits the received signal to the D/A converter 29. The D/A converter 29 D/A converts the received digital video signal and outputs the signal thus obtained to the display 37.

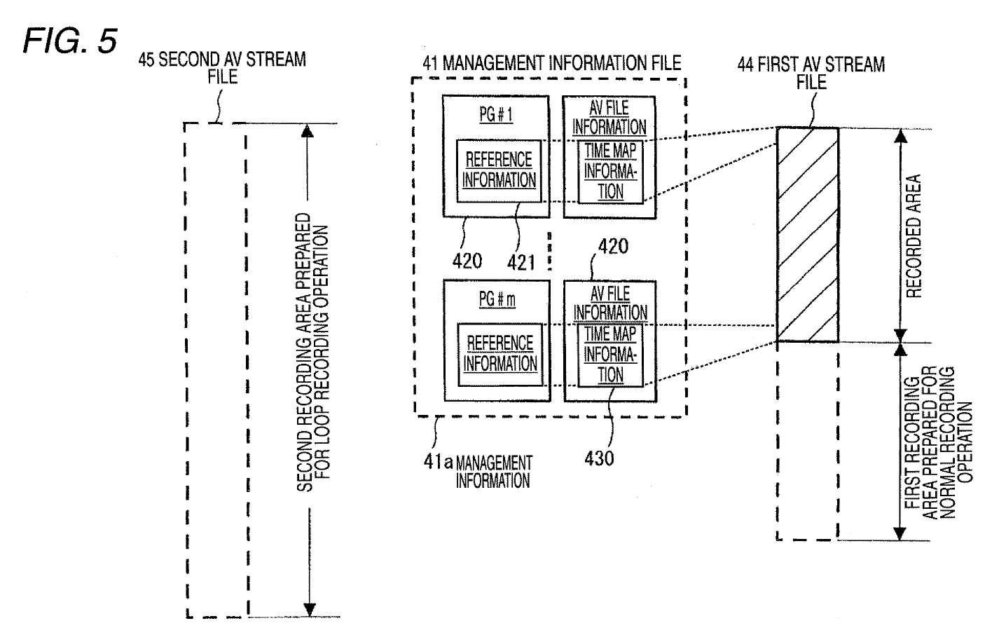

FIG. 5 is a diagram showing an example of usage of a plurality of AV stream files according to the first embodiment of the invention. In explanation in and after FIG. 5, there is assumed a mechanism for retaining the management information 41a on the memory (the work RAM 38) during the execution of the recording operation and recording the management information 41a in the management information file 41 on the HDD 14 in a recording end timing. This may be a mechanism for successively recording the management information 41a in the management information file 41 in the execution of the record processing.

A first recording area for the normal recording operation is prepared in the first AV stream file 44 to be used for the normal record processing. On the other hand, a second recording area for the loop recording operation is prepared in the second AV stream file 45 to be used for the loop record processing.

While titles of PG#1 to PG#m have already been recorded as the program group information 42 recorded in the normal recording operation and a recorded area is formed on the first AV stream file 44 in the example shown in FIG. 5, the notation will be omitted for convenience of the following description.

When the input keys 35 receive input of an instruction by the user, the recording method identifying section 153 determines whether the instruction of the user is related to the loop recording operation or not.

If the instruction of the user is related to the normal recording operation, the recording method identifying section 153 gives the normal recording section 156 an instruction for the normal record processing. Upon receipt of the instruction for the normal recording operation, the normal recording section 156 makes an inquiry to the recording area monitoring section 155 as to whether the recording area for the normal recording operation is prepared. Upon receipt of the inquiry, the recording area monitoring section 155 makes an inquiry to the FS managing section 152 as to whether the first or second AV stream file 44 or 45 is prepared for the recording area in the normal record processing. In the example, the normal record processing is assigned to the first AV stream file 44. Therefore, a file system having the first AV stream file 44 is given as a file system for the normal recording operation. The recording area monitoring section 155 determines whether or not the recording area (hereinafter referred to as a “first recording area”) for the normal recording operation is prepared on the first AV stream file 44 over the file system returned by the FS managing section 152, and transfers a result of the determination to the normal recording section 156.

As a result of the determination, if the first recording area is not prepared, the normal recording section 156 gives the recording area forming section 154 an instruction for maintaining the first recording area. The recording area forming section 154 forms the first recording area in the first AV stream file 44 of the HDD 14 and returns logical addresses of start and end points thereof to the normal recording section 156.

As a result of the determination, if the first recording area has been prepared or the first recording area is prepared by the recording area forming section 154, the normal recording section 156 generates the management information 41a in an initial state on a recording start point and holds the management information 41a on the internal memory (the work RAM 38). More specifically, the normal recording section 156 gives the management information managing section 151 an instruction for generating the management information 41a related to whole contents to be recorded in the program group information 42, the reference information 421 and the AV file information 43. Upon receipt of the instruction, the management information managing section 151 receives, from the normal recording section 156, the logical addresses of the start and end points of the first recording area returned by the recording area forming section 154 and sets them as the time map information 430 of the AV file information 43.

When the management information 41a is generated, the normal recording section 156 records the video and audio data transferred from the PS encoder 12 or the stream processor 22 in the first recording area prepared in the first AV stream file 44 on the HDD 14. During the recording operation in the first recording area, the management information managing section 151 generates the time map information 430 reflected corresponding to the progress of the recording operation of the AV data stream 400 every moment and records the time map information 430 in the AV file information 43 on the memory (the work RAM 38).

The recording area monitoring section 155 monitors the state of the first recording area which is recorded by the normal recording section 156 in the record processing of the normal recording section 156 and gives a notice to the normal recording section 156. More specifically, the recording area monitoring section 155 obtains a position on the HDD 14 (a position on the first AV stream file 44) in which the AV data stream 400 is recorded after the time map information 430 generated by the management information managing section 151 and compares the same position with the position of the end point of the first recording area which is held (the logical address on the recording media), thereby determining an arrival at the end point of the first recording area.

In the case in which the recording portion of the normal recording section 156 is not the end point of the first recording area, the normal recording section 156 determines whether the recording operation is ended or not. If the recording operation is not ended, the record processing is exactly performed continuously.

If the recording portion of the normal recording section 156 is the end point of the first recording area or the normal recording section 156 determines that the recording operation is ended, the normal recording section 156 gives an instruction of the end of the recording operation to the management information managing section 151. Upon receipt of the instruction, the management information managing section 151 records the recorded management information 41a as the management information file 41 in the HDD 14, and the normal recording section 156 ends the record processing and the management information managing section 151 closes the first AV stream file.

Then, the recording area forming section 154 forms a new first recording area and transfers logical addresses of start and end points thereof to the management information managing section 151. In a next normal recording operation, consequently, the recording area does not need to be prepared.

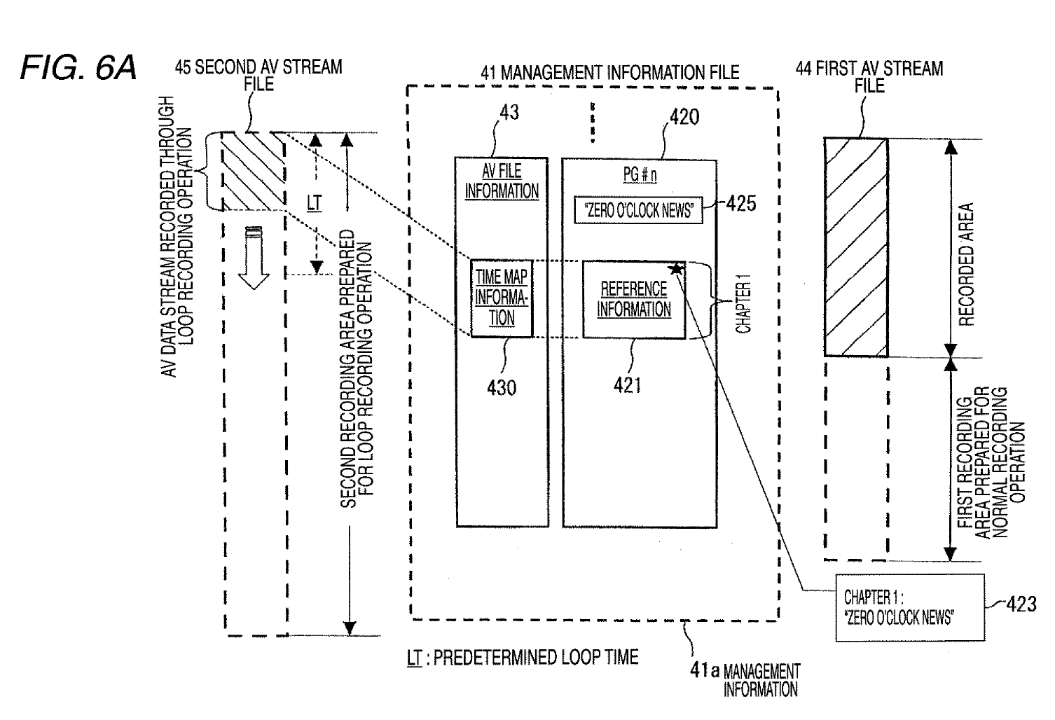

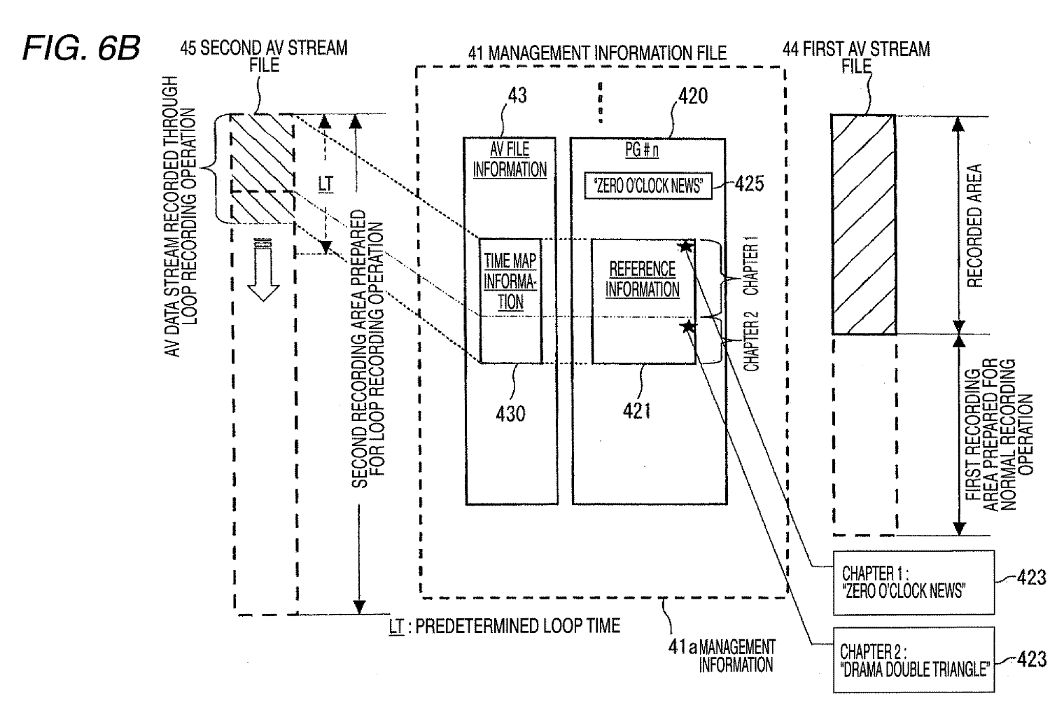

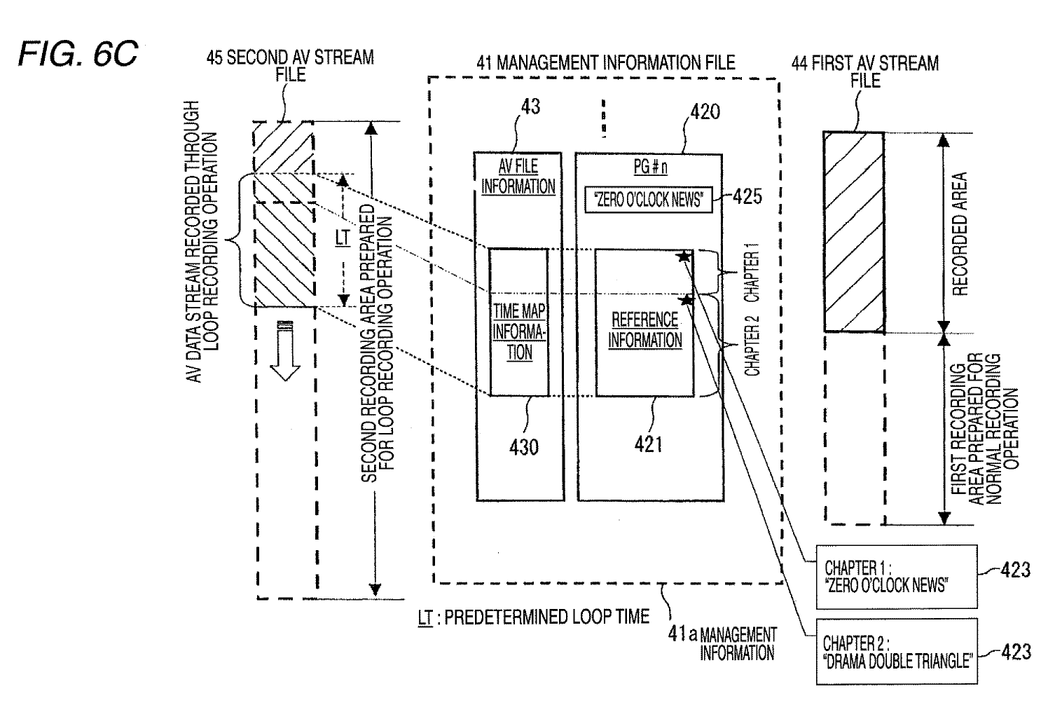

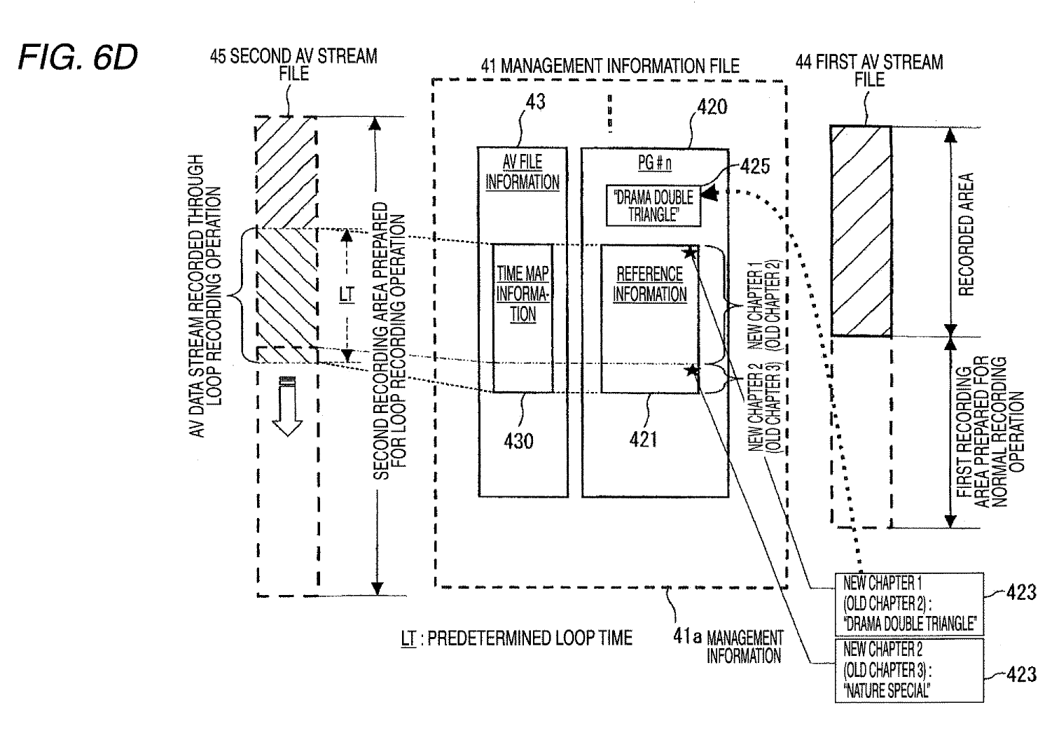

FIG. 6A is a diagram showing a state in which the loop recording operation according to the first embodiment is started, and FIGS. 6B to 6D are diagrams showing a state in which the loop recording operation according to the first embodiment of the invention progresses.

If the instruction of the user which is given through the input keys 35 indicates the loop recording operation, the recording method identifying section 153 gives the loop recording section 157 an instruction for the loop record processing. Upon receipt of the instruction for the loop recording operation, the loop recording section 157 makes an inquiry to the recording area monitoring section 155 as to whether the recording area for the loop recording operation is prepared. Upon receipt of the inquiry, the recording area monitoring section 155 makes an inquiry to the FS managing section 152 as to whether the recording area for the loop record processing is prepared in the first or second AV stream file 44 or 45. In the example, the loop record processing is assigned to the second AV stream file 45. Therefore, a file system having the second AV stream file 45 is given as a file system for the loop recording operation. The recording area monitoring section 155 determines whether or not the recording area (hereinafter referred to as a “second recording area”) for the loop recording operation is prepared on the second AV stream file 45 over the file system returned by the FS managing section 152, and transfers a result of the determination to the loop recording section 157.

The loop recording section 157 maintains the recording area of the second AV stream file 45 in a comparatively large size on the assumption that the AV data stream 400 having a maximum bit rate which can be supposed in respect of terrestrial/BS/CS digital broadcast standards is recorded for a long time, for example. In that case, the recording area of the second AV stream file 45 may be prepared in a configuration in which a margin is further provided for safety.

As a result of the determination, if the second recording area is not prepared, the loop recording section 157 gives the recording area forming section 154 an instruction for maintaining the second recording area. The recording area forming section 154 forms the second recording area in the second AV stream file 45 of the HDD 14 and returns logical addresses of start and end points thereof to the loop recording section 157.

As a result of the determination, if the second recording area has been prepared or the second recording area is prepared by the recording area forming section 154, the loop recording section 157 generates the management information 41a in an initial state on a recording start point and holds the management information 41a on the internal memory (the work RAM 38). More specifically, the loop recording section 157 gives the management information managing section 151 an instruction for generating the management information 41a related to whole contents to be recorded in the program group information 42, the reference information 421 and the AV file information 43. Upon receipt of the instruction, the management information managing section 151 receives, from the loop recording section 157, the logical addresses of the start and end points of the second recording area returned by the recording area forming section 154 and sets them as the time map information 430 of the AV file information 43.

When the management information 41a is generated, the loop recording section 157 records the video and audio data transferred from the PS encoder 12 or the stream processor 22 in the second recording area prepared in the second AV data stream on the HDD 14 as shown in FIG. 6A.

In FIG. 6A, contents are recorded as PG#n and the AV data stream 400 is started to be recorded at the head of the second AV stream file 45. A predetermined loop time which is preset by an initialization is represented as LT. In a state shown in FIG. 6A, the predetermined loop time LT does not pass since the start of the loop recording operation. In the state shown in FIG. 6A, moreover, a program name acquired from a program information used in a display of an EPG (ELECTRONIC PROGRAM GUIDE) screen at the start of the loop recording operation is set to both a name of the contents (“Zero O'clock News” shown in FIG. 6A) and a name of the chapter 422. It is assumed that a program information processing unit 39 acquires the EPG to be the program information through an analog broadcast, a digital broadcast and a network.

During the recording operation in the second recording area, the management information managing section 151 generates the time map information 430 reflected corresponding to the progress of the recording operation of the AV data stream 400 every moment and records the time map information 430 in the AV file information 43 on the memory. As shown in FIG. 6A, the AV data stream 400 to be recorded through the loop recording operation is recorded in the second recording area and the time map information 430 to be the management information 41a corresponds to the AV data stream recorded in the second recording area.

The recording area monitoring section 155 monitors the state of the second recording area which is recorded by the loop recording section 157 in the record processing of the loop recording section 157 and gives a notice to the loop recording section 157. More specifically, the recording area monitoring section 155 obtains a position on the HDD 14 (a position on the second AV stream file 45) in which the AV data stream 400 is recorded after the time map information 430 generated by the management information managing section 151 and compares the same position with the position of the end point of the second recording area (the logical address on the recording media) which us held, thereby determining an arrival at the end point of the second recording area.

In the case in which the recording portion of the loop recording section 157 is not the end point of the second recording area, the loop recording section 157 determines whether the recording operation is ended or not. If the recording operation is not ended, the record processing is exactly performed continuously. If the loop recording section 157 does not determine that the recording operation is ended, the loop record processing is continuously performed so that an overwrite is repetitively performed in the second recording area.

In the case in which the recording portion of the loop recording section 157 is the end point of the second recording area, the loop recording section 157 moves a file pointer (a recording point) of the second AV stream file 45 to a position of the start point of the second recording area which is held (a logical address on the recording media). Consequently, the subsequent AV data stream 400 is recorded as overwrite recording from the start point of the second recording area. Thus, the overwrite recording to use an inner part of the second recording area which is held, that is, the loop record processing is performed.

In the case in which a loop-back is generated in the second recording area, it is necessary to adjust a starting position of the recording start for the second AV stream file 45 in the time map information 430. The management information managing section 151 shifts the starting position of the recording start for the subsequent AV data stream later on a time basis through the overwrite recording operation.

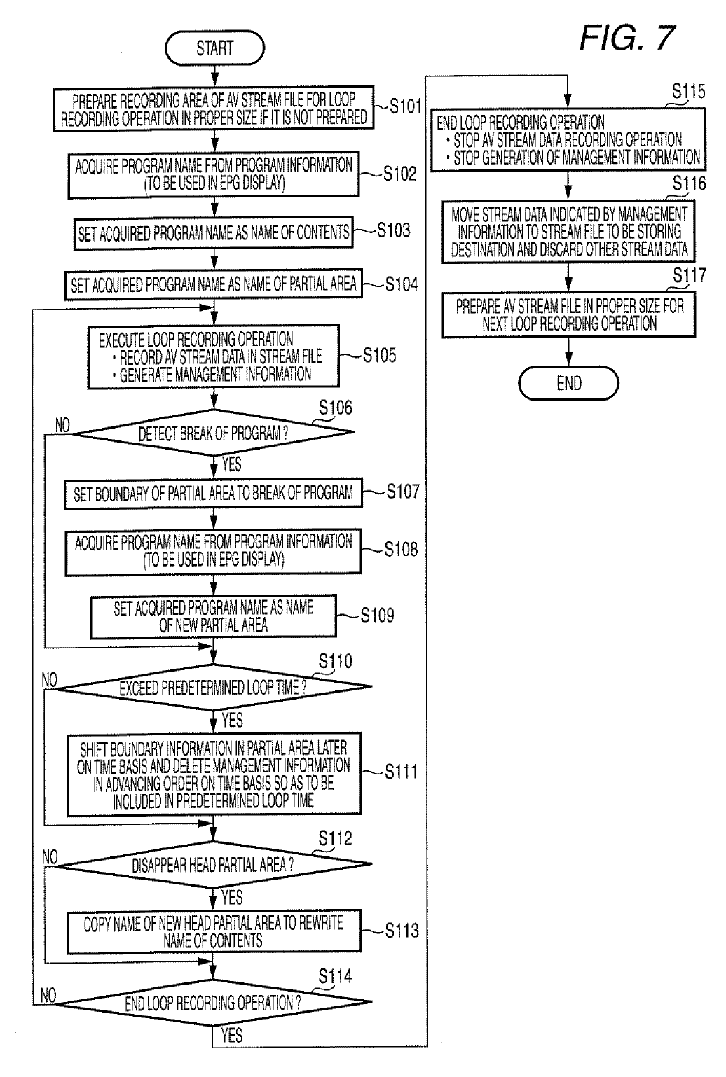

A contents name setting operation for loop recorded contents will be described below in accordance with a flowchart of FIG. 7. Referring to the detailed operation, the same portions as the operation described above will be simplified and explained.

A user performs an operation for loop recording a desirable program through the input keys 35 over the recording apparatus 10 of the television system 1.

The recording area monitoring section 155 determines whether the recording area of the second AV stream file 45 is prepared or not. If the recording area is not prepared, the recording area of the second AV stream file 45 to be used for the loop recording operation through the recording area forming section 154 is prepared in the HDD 14 (S101).

The program information processing unit 39 acquires a program name from a program information to be used in the display of the EPG screen (S102). A name of the program to be recorded through the loop recording operation is acquired.

Next, the management information managing section 151 sets the program name acquired at the Step S102 as a name is of contents (“Zero O'clock News” shown in FIG. 6A) as shown in FIG. 6A (S103). Thus, a program name is set to the area for retaining the program text information 425 provided in the individual program group information 42 described with reference to FIGS. 2 and 3.

The management information managing section 151 similarly sets the program name acquired at the Step S102 as a name of the chapter 422 to be a partial area in the contents (S104). This is set to be the text information 423b of the chapter boundary information 423 set into the reference 25 information 421 shown in FIG. 2. At the step 104, moreover, a name of the first chapter 422 in the contents is set.

Next, the loop recording section 157 executes the loop recording operation over the second AV stream file 45 to be a recording target file (S105; storing step). Moreover, the AV data stream 400 is recorded in the second AV stream file 45, and furthermore, the management information 41a is also generated by the management information managing section 151 (generating step). More specifically, as shown in FIGS. 6A to 6D, the time map information 430 reflected corresponding to a progress of the recording operation for the AV data stream 400 is generated and time stamp information about the end point of the reference information 421 is updated and held on the internal memory (the work RAM 38).

Subsequently, the loop recording section 157 determines whether a break of a program in the contents recorded endlessly through the loop recording operation is detected or not, and branches the processing. This is performed by a method of detecting a break of a program based on an information about start and end times of a program acquired from the program information to be used for the display of the EPG screen and a time length of the program, a time information acquired from a clock built in the recording apparatus 10 or an information about a time length of the partial area (the chapter 422) in the contents, for example. If the break of the program is detected (S106; Yes), the processing proceeds to a subsequent step 107. On the other hand, if the same break is not detected (S106; No), the steps 107 to 109 are skipped and the processing proceeds to step 110.

As shown in FIG. 6B, the loop recording section 157 sets the chapter boundary information 423 of the chapter 422 to be the partial area in the contents recorded endlessly through the loop recording operation into a position of the break of the program detected at the step 106 (S107). By the processing performed at the step 107, the chapter 422 to be the partial area in the contents recorded endlessly through the loop recording operation is set in an interlocking form with a program to be a display unit of the EPG screen. More specifically, the individual chapter 422 corresponds to the individual program displayed on the EPG screen, and furthermore, the number of the partial areas in the contents recorded endlessly through the loop recording operation (the number of the chapters 422) indicates the number of the programs included in the contents.

The management information managing section 151 acquires a name of a program from the program information to be used for the display of the EPG screen through the program information processing unit 39 (S108). There is acquired a name of a new program started at the break of the program shown in FIG. 6B (a “drama double triangle” shown in FIG. 6B).

The management information managing section 151 sets the name of the program acquired at the step 108 as the name of the chapter 422 to be the partial area in the contents (S109). This is set as the text information 423b of the chapter boundary information 423 set into the reference information 421 as shown in FIG. 3. At the step 109, moreover, there is set the name of the new chapter 422 in which the position of the chapter boundary information 423 set to the break of the program is used as the start point.

More specifically, by a series of processing from the steps 106 to 109, the chapter 422 to be the partial area is set on a program unit in the contents recorded endlessly in the loop recording operation, and furthermore, the management information managing section 151 sets a name of a program corresponding to the chapter 422 as the name of the chapter 422.

The management information managing section 151 compares a valid time length of the contents which are obtained from the management information 41a and are being recorded with the predetermined loop time LT, and branches a subsequent processing. If the valid time length of the contents which are being recorded exceeds the predetermined loop time LT (S110; Yes), the processing proceeds to a next step 111. On the other hand, if the valid time length of the contents which are being recorded does not exceed the predetermined loop time LT (S110; No), the step 111 is skipped and the processing proceeds to step 112.

As shown in FIGS. 6C and 6D, the management information managing section 151 updates the start point of the management information 41a to a position going back to a past by the time length of the predetermined loop time LT from a current record advancing position (S111). More specifically, only the past management information 41a is made valid corresponding to the time length of the predetermined loop time LT from the current record advancing position and the previous and old management information 41a is cancelled.

More specifically, the management information managing section 151 deletes the time map information 430 corresponding to a position to be cancelled, and updates a time stamp of the start point of the reference information 421 which is linked thereto in such a form as to shift the contents later on a time basis. Consequently, access cannot be given to the AV data stream 400 corresponding to the cancelled management information 41a so that an invalid AV data stream 400 is obtained.

When the loop recording operation further progresses to reach a termination of the second AV stream file 45, the management information managing section 151 seeks (retrieves) the file pointer and the new AV data stream 400 is overwritten and recorded in the area in which the invalid AV data stream 400 is recorded. At the step 111, moreover, the start point of the reference information 421 is shifted later on a time basis and the position of the chapter boundary information 423 set to the start position of the reference information 421 is also shifted later on a time basis. In other words, the position information 423a which is possessed by the chapter boundary information 423 and to which the chapter boundary information 423 is set (the time stamp 424 on the reference information 421) is rewritten to shift the set position.

By the step of the step 111, as shown in FIGS. 6C and 6D, the management information managing section 151 gradually contracts any of the chapters 422 to be the partial areas in the contents which is positioned on the head in the contents in advancing order on a time basis with the progress of the loop recording operation. When the loop recording operation is performed further continuously, the chapter boundary information set to the start point of the head chapter 422 in the contents is shifted further later on a time basis and shortly intersects another chapter boundary information set to the start point of the second chapter 422 positioned later on a time basis in the contents. The generation of the intersection implies that the older chapter 422 on a time basis disappears. In the case in which the intersection of the chapter boundary information 423 is generated, the management information managing section 151 deletes the chapter boundary information 423 set to the start point of the chapter 422 which is older on a time basis and disappears. Instead, the chapter boundary information 423 set to the start point of the chapter 422 on the head in new contents is subsequently shifted later on a time basis with the progress of the loop recording operation.

The management information managing section 151 determines whether the chapter 422 to be the partial area on the head in the contents disappears or not, and branches a subsequent processing. If the chapter 422 on the head disappears (S112; Yes), the processing proceeds to a next step 113. On the other hand, if the chapter 422 on the head does not disappear (S112; No), the step 113 is skipped to cause the processing to proceed to step 114.

The management information managing section 151 rewrites the name of the contents by copying a name of the chapter 422 (a drama double triangle shown in FIG. 6D) which newly acts as the partial area on the head in the contents in place of the disappearing chapter 422 (S113; updating step). More specifically, by a series of processing from the step 112 to the step 113, the management information managing section 151 updates the management information 41a by always setting, as the name of the contents, the name of the program corresponding to the chapter 422 positioned on the head.

The loop recording section 157 determines whether the loop record operation is ended based on the user's manipulation for the input keys 35 or not, and branches the processing. If the loop recording operation is not ended (S114; No), the processing returns to the step 105 and the loop recording operation is continuously performed. If the loop recording operation is ended (S114; Yes), the processing proceeds to a subsequent step 115.

The loop recording section 157 stops the loop recording operation for the second AV stream file 45 based on the user's manipulation through the input keys 35 (S115). The recording operation for the AV data stream 400 in the second AV stream file 45 is stopped and the processing of updating the management information 41a, for example, the generation of the time map information 430 is also stopped.

The management information managing section 151 moves the area in which the AV data stream 400 indicated by the management information 41a is recorded from the second AV stream file 45 to the first AV stream file 44 to be an archive file (S116). By executing the processing, it is possible to store the loop recorded contents in the HDD 14.

For example, in the case in which a file system based on the UDF standards is used, the management information managing section 151 moves an extent corresponding to the area in which the AV data stream 400 indicated by the management information 41a is recorded from a file entry of the second AV stream file 45 to that of the first AV stream file 44.

More specifically, the management information managing section 151 rewrites the description of both of the file entries of the second and first AV stream files 45 and 44 in such a manner that the extent indicated by the file entry of the second AV stream file 45 takes a form indicated by the file entry of the first AV stream file 44.

In the loop recording operation, the area in which the AV data stream 400 indicated by the management information 41a is recorded sometimes takes such a separating form that a first half part is present in an end portion of the storage area for the second AV stream file 45 and a second half part is present in a head portion of the same area. When performing the movement from the second AV stream file 45 to the first AV stream file 44, accordingly, it is necessary to perform the movement while ensuring a consistency of the reproducing order.

Moreover, the management information managing section 151 discards the AV data stream 400 which is not indicated by the management information 41a. The reason is that the area in which the AV data stream 400 to be a non-moving target is recorded is brought into a non-using state and is to be recycled in a next recording operation. In the movement processing, the time map information 430 included in the management information 41a is rewritten to indicate the logical address information in the first AV stream file 44. Accordingly, the management information 41a held on the internal memory (the work RAM 38) is written to the management information file 41 after the end of the movement processing.

The management information managing section 151 resets and maintains the second AV stream file 45 to have an empty area in a predetermined amount (S117) and the series of processing is ended in such a manner that the same area can be used as a new recording target file in a next loop recording operation. Also at the step 117, in the same manner as the step 101, the recording area of the second AV stream file 45 is prepared in a comparatively large size to prepare for the next loop recording operation on the assumption that the AV data stream 400 having a maximum bit rate which can be supposed in respect of terrestrial/BS/CS digital broadcast standards is recorded for a long time, for example.

According to the first embodiment, the name of the program corresponding to the head chapter 422 in the contents is always set to be the name of the contents which are recorded through the loop recording operation. Consequently, a name of a program which has not been present in the contents is not continuously left as the name of the contents, and the oldest one of the program names on a time basis is set to be the name of the contents in the recorded contents when the user gives an instruction for stopping the recording operation. Therefore, there is brought a state in which a consistency of the recorded contents with the name of the contents is taken. Thus, a convenience of the user can be enhanced.

### Second Embodiment

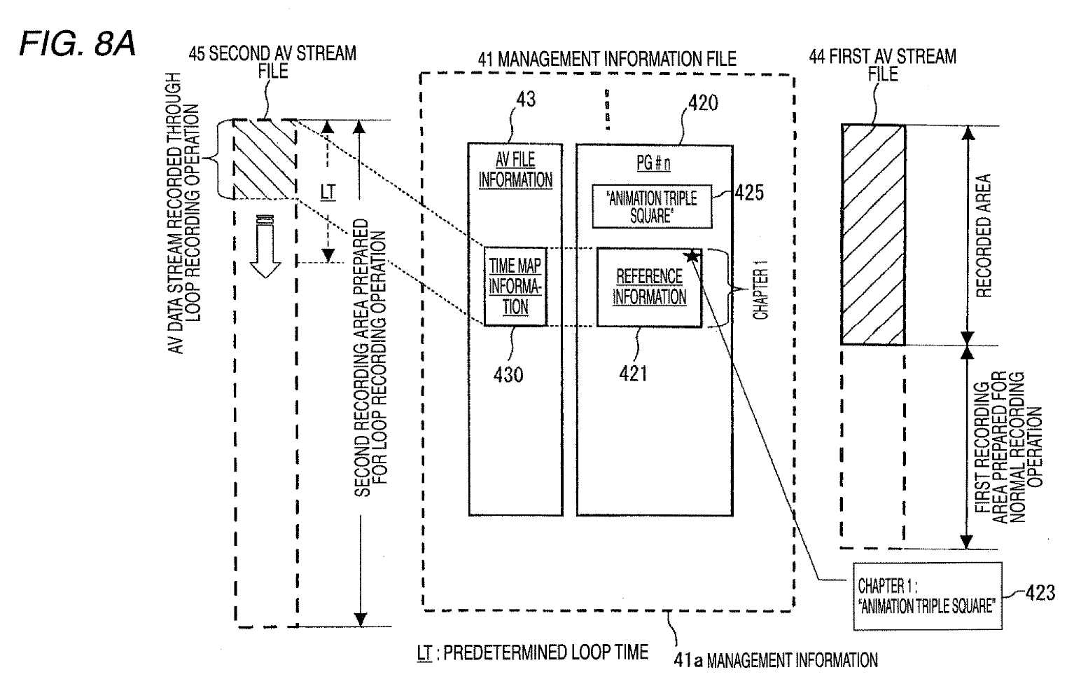

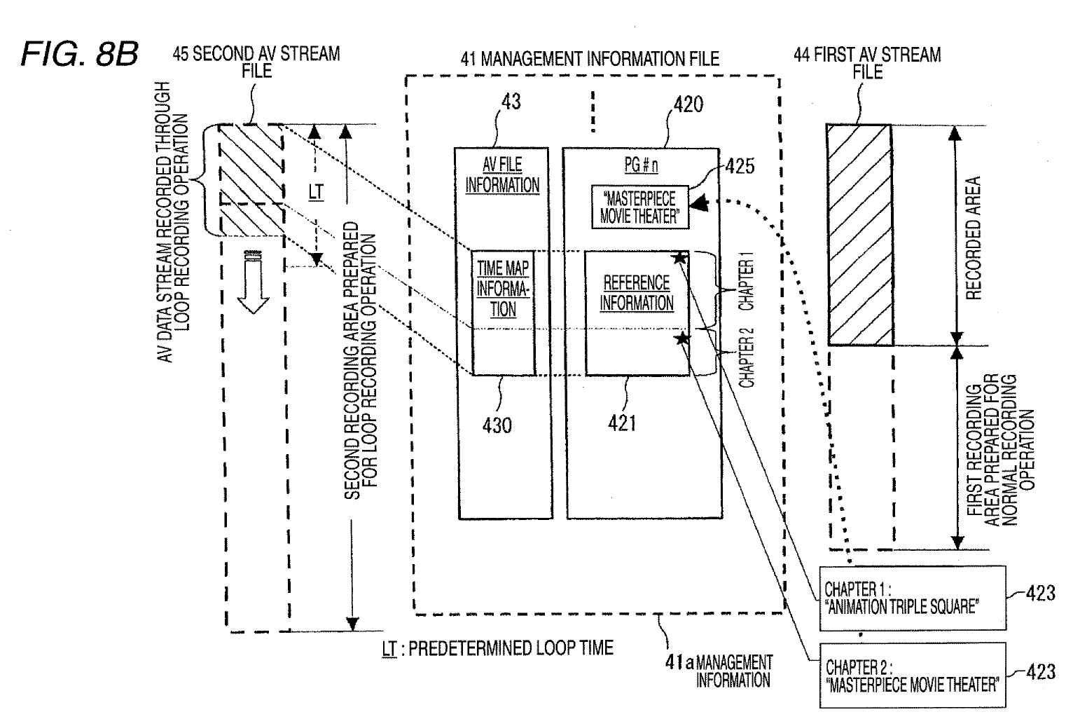

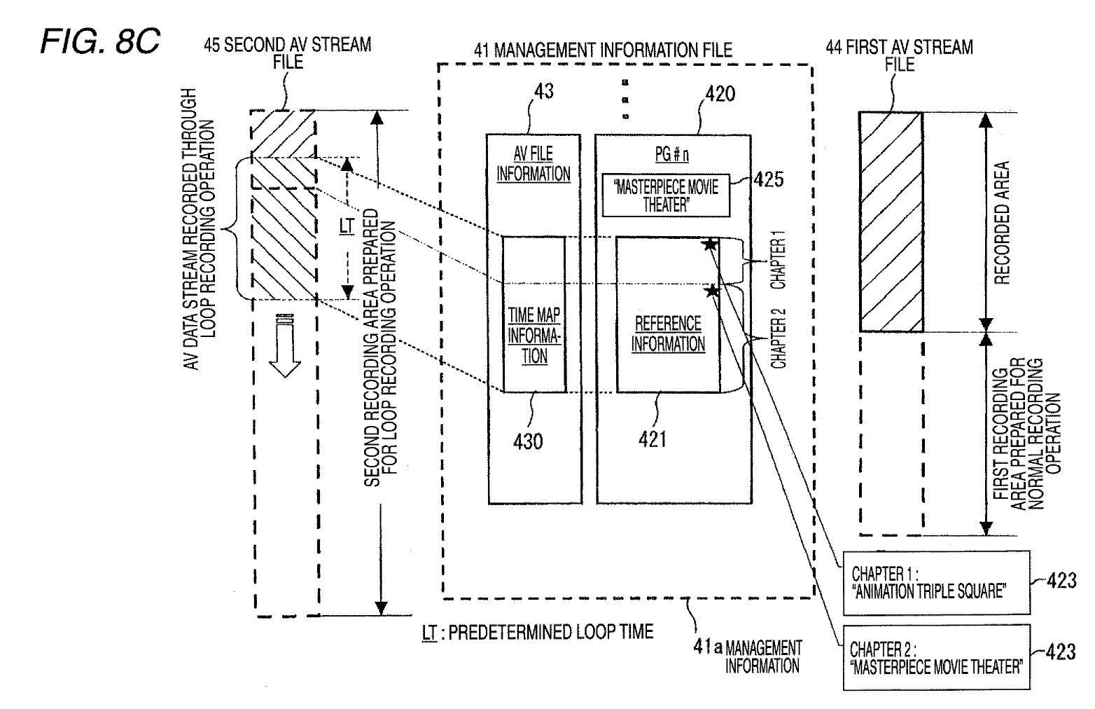

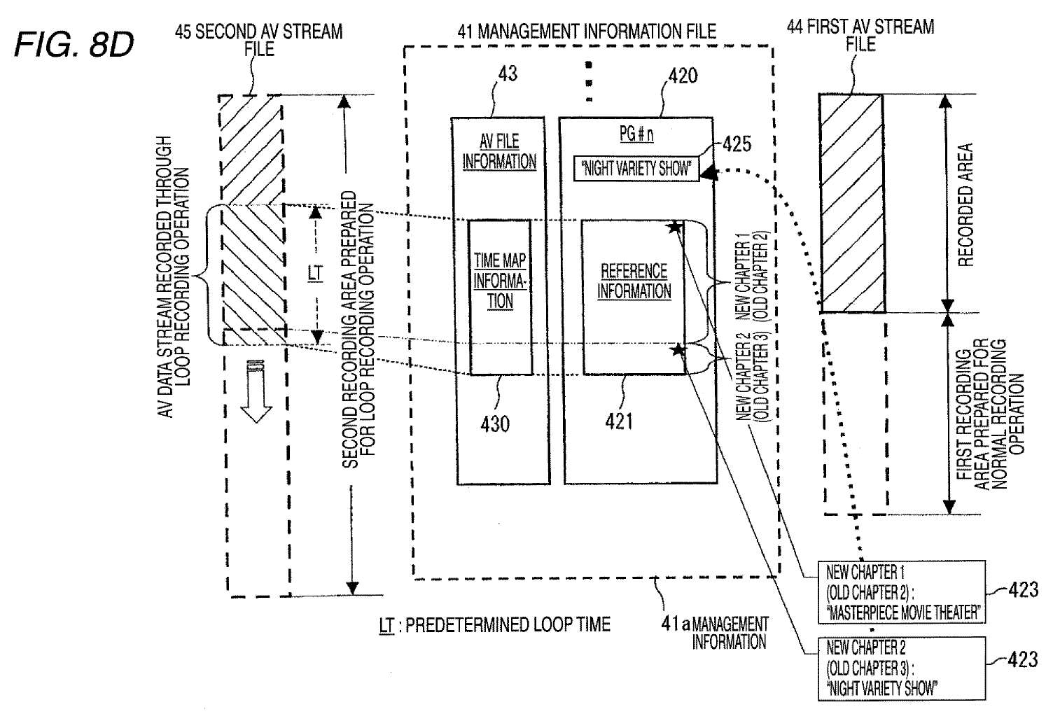

FIG. 8A is a diagram showing a state in which a loop recording operation according to a second embodiment of the invention is started, and FIGS. 8B to 8D are diagrams showing a state in which the loop recording operation according to the second embodiment of the invention progresses. In the following description, portions having the same structures and functions as those in the first embodiment have common reference numerals. Since the configuration of the recording apparatus 10 according to the embodiment is identical to that of the first embodiment, moreover, only different operations will be described.

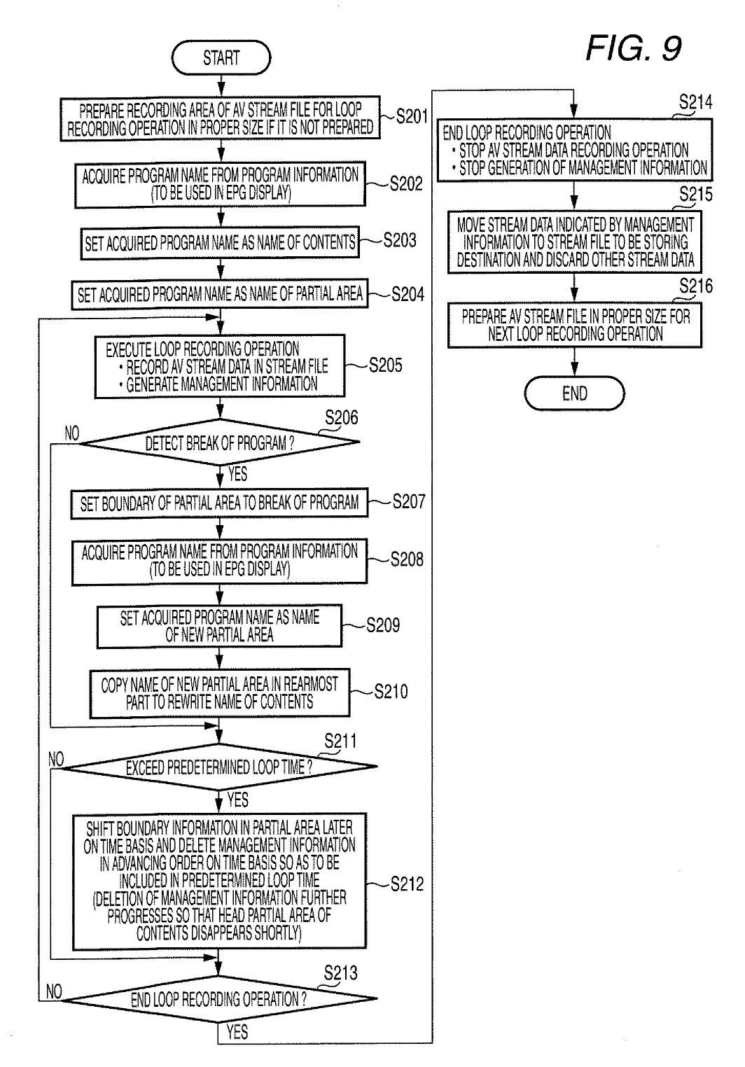

In the embodiment, in the same manner as in the first embodiment, it is assumed that a second AV stream file 45 is used in a loop recording operation and a first AV stream file 44 for a normal recording operation is used as an archive file. In a flowchart of FIG. 9, only a loop record processing will be described and the description of the summary of the normal record processing will be omitted. It is assumed that a predetermined loop time LT is preset by a user's operation prior to the start of the loop recording operation, which is not shown in FIG. 9. The loop recording operation according to the second embodiment will be described in accordance with the flowchart of FIG. 9.

Steps 201 to 209 are the same as the steps 101 to 109 according to the first embodiment.

At a subsequent step 210, a management information managing section 151 rewrites a name of contents by copying a name of a chapter 422 which is newly generated by a division, that is, a name of the final chapter 422 in the contents (“Masterpiece Movie Theater” shown in FIG. 8B) as shown in FIG. 8B.

More specifically, by a series of processing from the step 201 to the step 210, the chapter 422 to be a partial area is set on a program unit into the contents recorded endlessly in a loop recording operation, and furthermore, a name of a program corresponding to the chapter 422 is set as the name of the chapter 422.

By the series of processing from the step 201 to the step 210, moreover, a name of a program corresponding to any of the chapters 422 (the newest chapter 422) to be partial areas in the contents which is always positioned in a rearmost part is set as the name of the contents. By the processing, the name of the contents subjected to the loop recording operation is set to be a name of a program recorded most newly. Therefore, a name of a program which has not been present in the contents is not continuously left as the name of the contents.

Steps 211 to 216 are performed in the same manner as the steps 110 to 117 according to the first embodiment (a corresponding processing to the steps 112 and 113 are not present in the flowchart of FIG. 9), and the processing is ended.

According to the second embodiment, the name of the program corresponding to the chapter 422 on the rearmost part in the contents is always set to be the name of the contents which are recorded through the loop recording operation. Consequently, a name of a program which has not been present in the contents is not continuously left as the name of the contents, and the newest one of the program names on a time basis in the recorded contents is set to be the name of the contents when the user gives an instruction for stopping the recording operation. Therefore, there is brought a state in which a consistency of the recorded contents with the name of the contents is taken. Thus, a convenience of the user can be enhanced.

### Third Embodiment

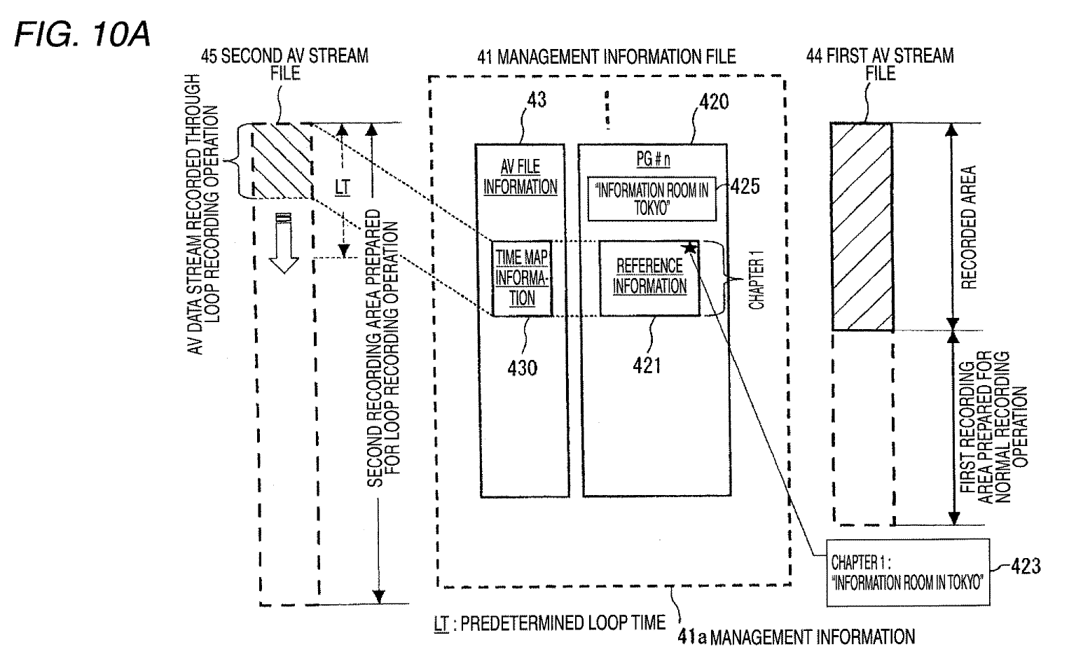

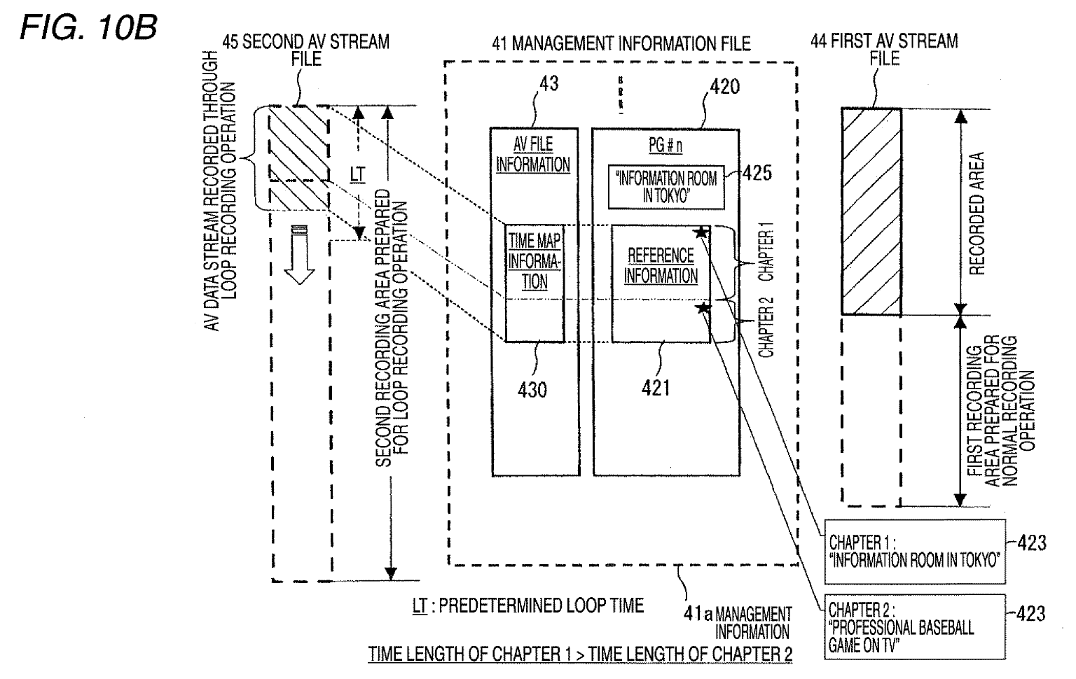

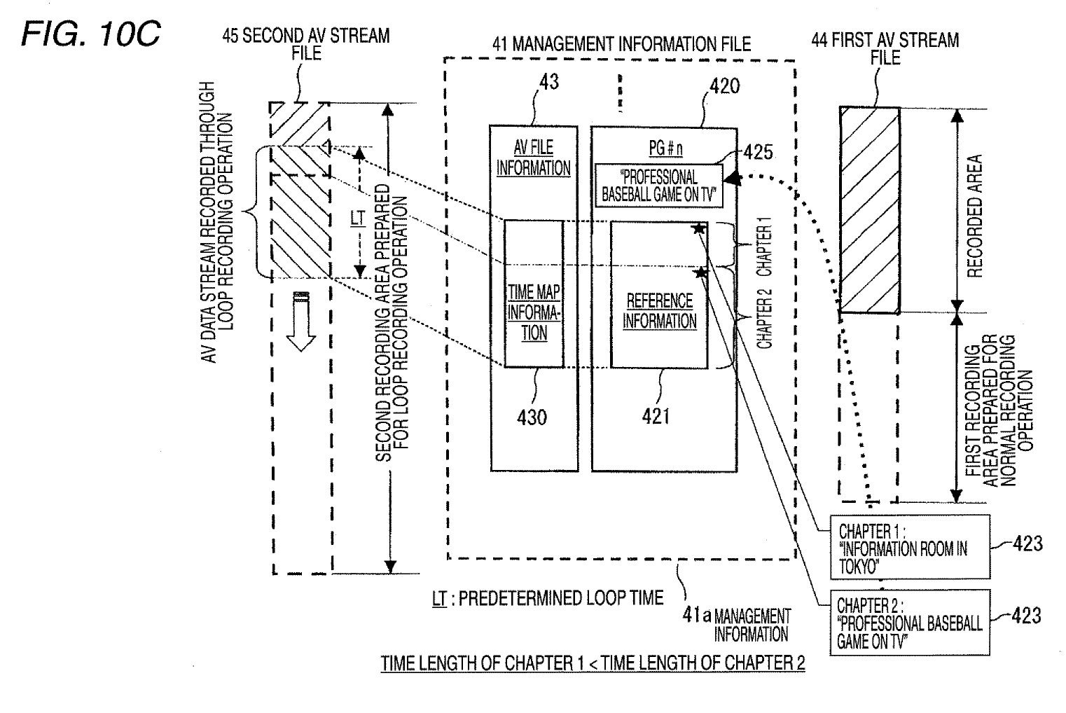

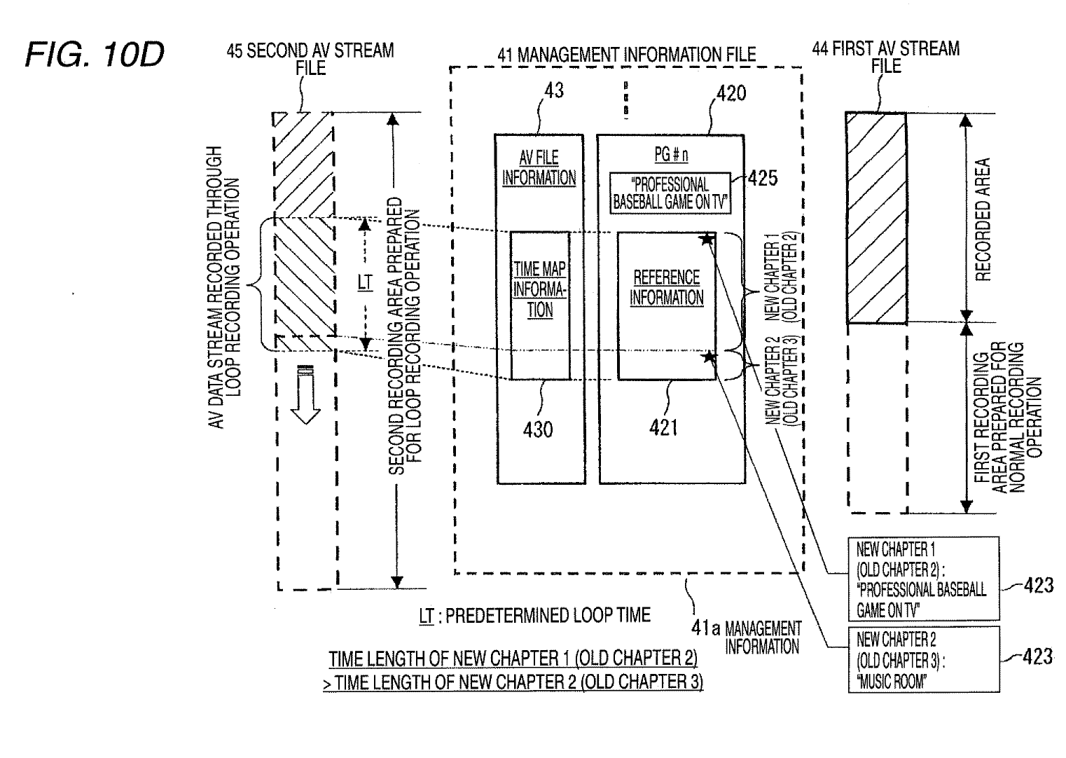

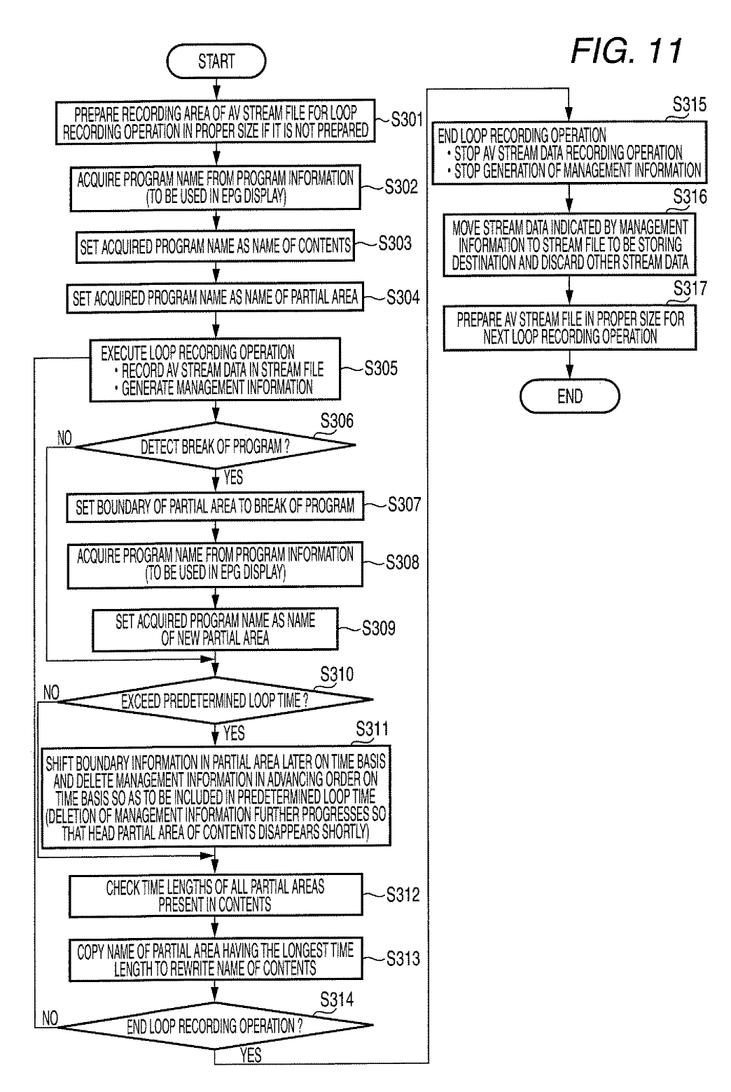

FIG. 10A is a diagram showing a state in which a loop recording operation according to a third embodiment of the invention is started, and FIGS. 10B to 10D are diagrams showing a state in which the loop recording operation according to the third embodiment of the invention progresses. Only different operations will be described in accordance with flowcharts of FIGS. 11 to 13.

Steps 301 to 311 are the same as the steps 101 to 111 according to the first embodiment.

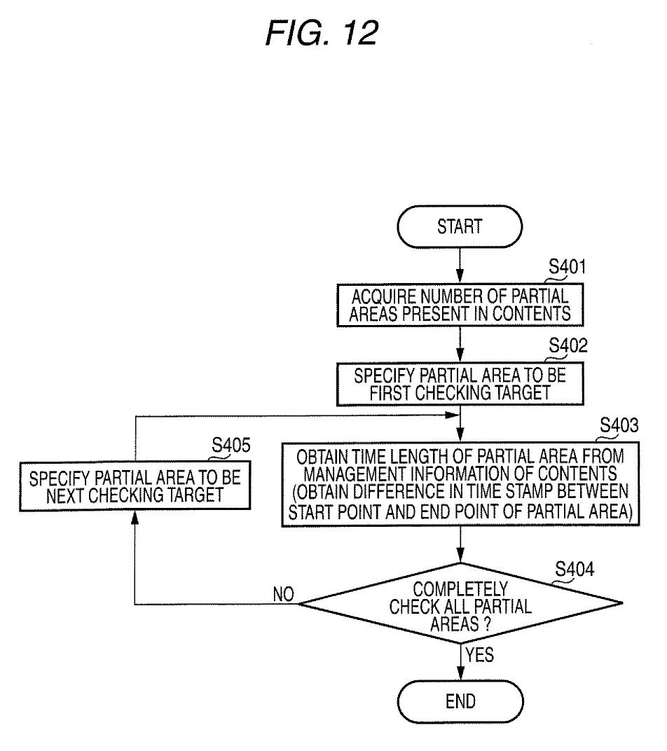

At a subsequent step 312, a management information managing section 151 checks time lengths in all partial areas present in contents. In accordance with the flowchart of FIG. 12, description will be given to a processing of checking the time lengths of all the partial areas (chapters 422) present in the contents at the step 312.

At step 401, first, the management information managing section 151 acquires the number of the chapters 422 to be the partial areas in the contents.

At step 402, next, the management information managing section 151 specifies the chapter 422 to be a first checking target.

At step 403, subsequently, the management information managing section 151 obtains a time length of the chapter 422 to be the checking target. Herein, it is assumed that a time length is obtained from management information 41a of contents. More specifically, a difference between time stamps on start and end points in the chapter 422 to be the checking target is obtained to acquire the time length of the chapter 422 to be the checking target.

At step 404, finally, the management information managing section 151 determines whether the operation for checking the time lengths of all the chapters 422 in the contents is ended or not, and branches the processing. If the checking operation is not ended (S404; No), the processing proceeds to step 405 and the chapter 422 to be a next checking target is specified (S405), and the processing then returns to the step 403 to continuously perform the checking operation. If the processing for the time lengths of all the chapters 422 is ended (S404; Yes), the serial check processing is ended.

At the step 312, the management information managing section 151 ends the operation for checking the time lengths of all the partial areas present in the contents, and then starts the processing of step 313.

At the step 313, the management information managing section 151 rewrites the name of the contents by copying a name of any of the chapters 422 to be the partial areas in the contents which has the longest time length.

More specifically, by the series of processing from the step 312 to the step 313, a name of a program corresponding to any of the chapters 422 to be the partial areas in the contents which has the longest time length (that is, a program having the longest time length) is always set to be the name of the contents. For example, a chapter 1 “Information Room in Tokyo” is set to be the name of the contents in FIG. 10A, and the chapter 1 “Information Room in Tokyo” has a longer time length than a chapter 2 “Professional Baseball Game on TV” also in FIG. 10B. Therefore, the chapter 1 “Information Room in Tokyo” is set to be the name of the contents. On the other hand, in FIG. 10C, the chapter 2 “Professional Baseball Game on TV” has a longer time length than the chapter 1 “Information Room in Tokyo”. Therefore, the chapter 2 “Professional Baseball Game on TV” is set to be the name of the contents. In FIG. 10D, a new program is loop recorded. Since a new chapter 1 “Professional Baseball Game on TV” has a longer time length than a new chapter 2 “Music Room”, however, the chapter 1 “Professional Baseball Game on TV” is set to be the name of the contents.

Steps 314 to 317 are performed in the same manner as the steps 114 to 117 according to the first embodiment, and the processing is ended.

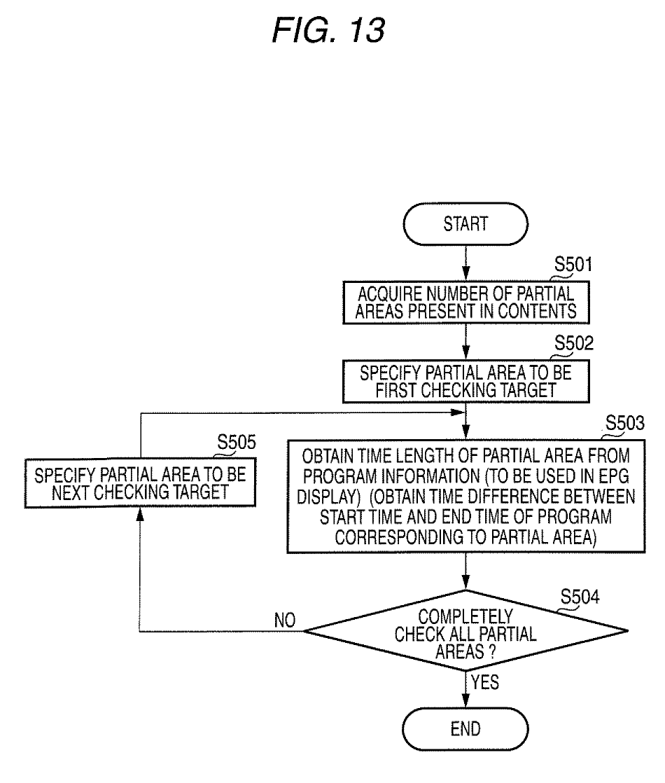

Another example of the processing of checking the time lengths of all the partial areas (chapters 422) present in the contents at the step 312 will be described in accordance with a flowchart of FIG. 13.

At step 501, first, the management information managing section 151 acquires the number of the chapters to be the partial areas in the contents.

At step 502, next, the management information managing section 151 specifies the chapter 422 to be a first checking target.

At step 503, subsequently, the management information managing section 151 obtains a time length of the chapter 422 to be the checking target. Herein, it is assumed that a time length is obtained from program information to be used for a display on an EPG screen. More specifically, a difference between start and end times of a program corresponding to the chapter 422 to be the checking target is obtained to acquire the time length of the chapter 422 to be the checking target.

At step 504, finally, the management information managing section 151 determines whether the operation for checking the time length of all the chapters 422 in the contents is ended or not, and branches the processing. If the checking operation is not ended (S504; No), the processing proceeds to step 505 and the chapter 422 to be a next checking target is specified, and the processing then returns to the step 503 to continuously perform the checking operation. If the processing for the time lengths of all the chapters 422 is ended (S504 Yes), the serial check processing is ended.

According to the third embodiment, when the user gives an instruction for stopping the recording operation, the name of the program corresponding to the chapter 422 having the longest time length in the recorded contents is always set to be the name of the contents recorded through the loop recording operation. Consequently, a name of a program which has not been present in the contents is not continuously left as the name of the contents so that there is brought a state in which a consistency of the recorded contents with the name of the contents is taken.

First Modification

In the first to third embodiments, the description has been given to the example of the loop recording operation based on a time in which the predetermined loop time LT is preset by the user's operation and the management information 41a is left corresponding to only a position obtained by going back from the record advancing position by the predetermined loop time LT, and the previous and old management information 41a on a time basis is discarded.

On the other hand, there is also an example of a loop recording operation which is not based on a time. More specifically, there is a loop recording method based on the number of programs in which a break of a program is detected in contents recorded endlessly through the loop recording operation, the chapter boundary information 423 of the chapter 422 to be the partial area in the contents is set to the break, thereby generating the chapter 422 corresponding to the program in the contents and setting an upper limit number of the programs present previously in the contents (which is equal to the number of the chapters in this case) to prevent the number of the chapters in the contents (the number of the programs) from exceeding the upper limit number. In this case, the management information 41a is deleted on a unit of the number of chapters 422 which exceeds the upper limit number in advancing order on a time basis. A first modification will be described below.

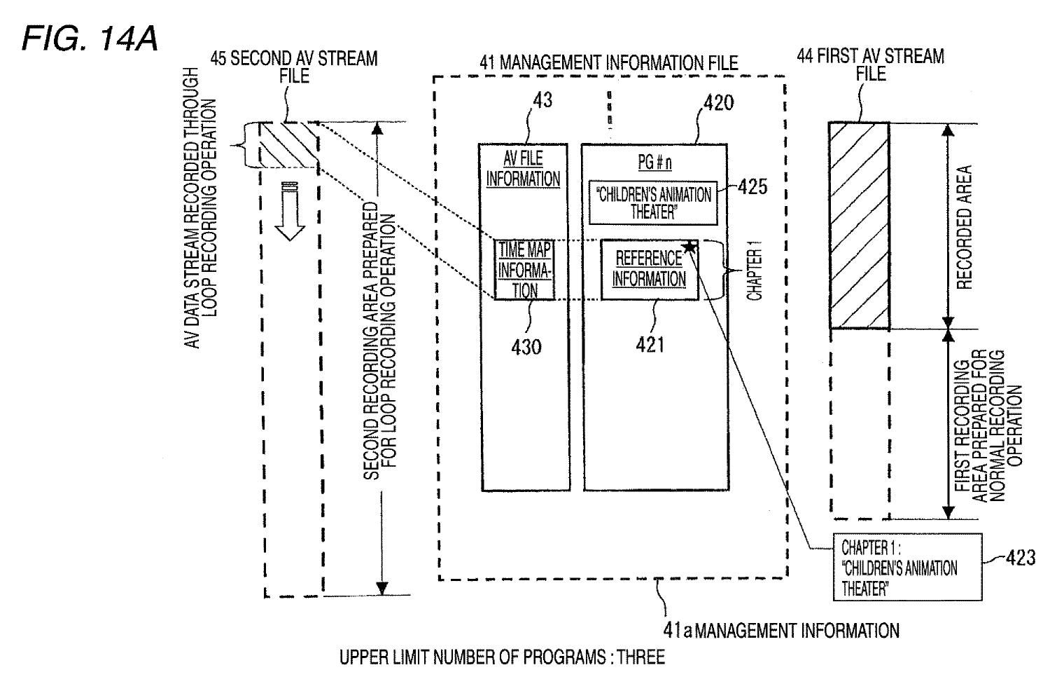

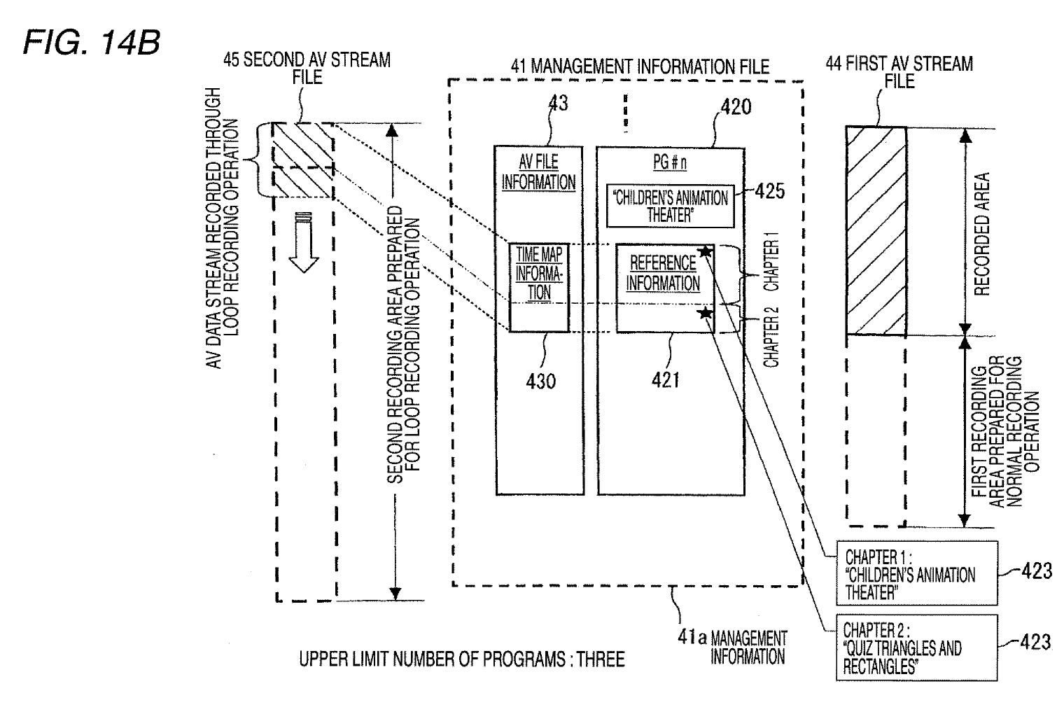

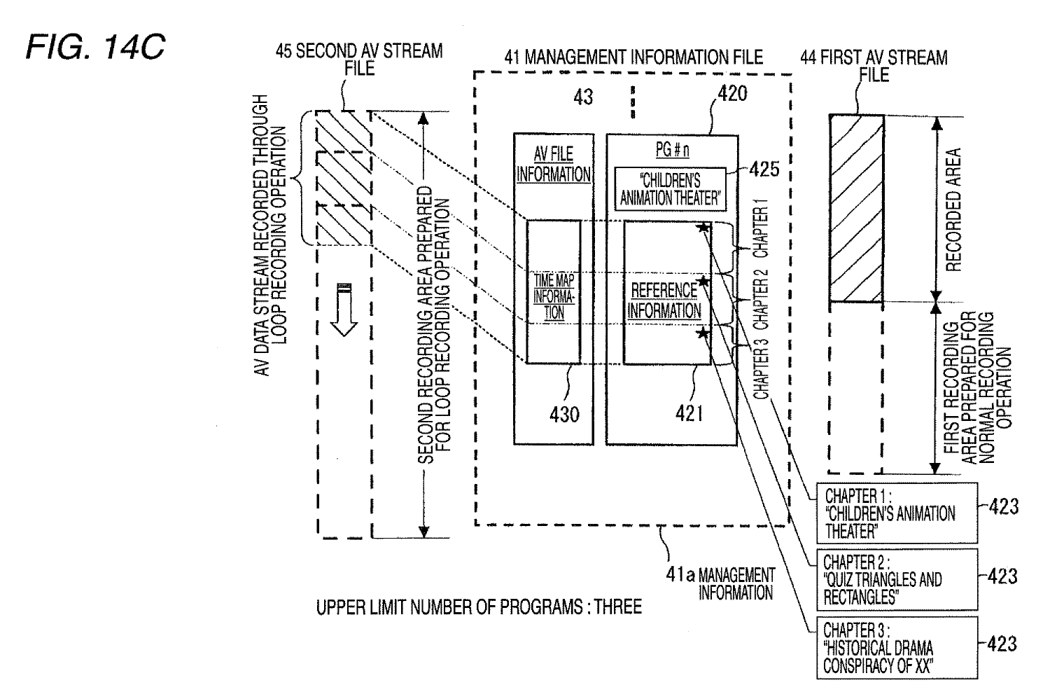

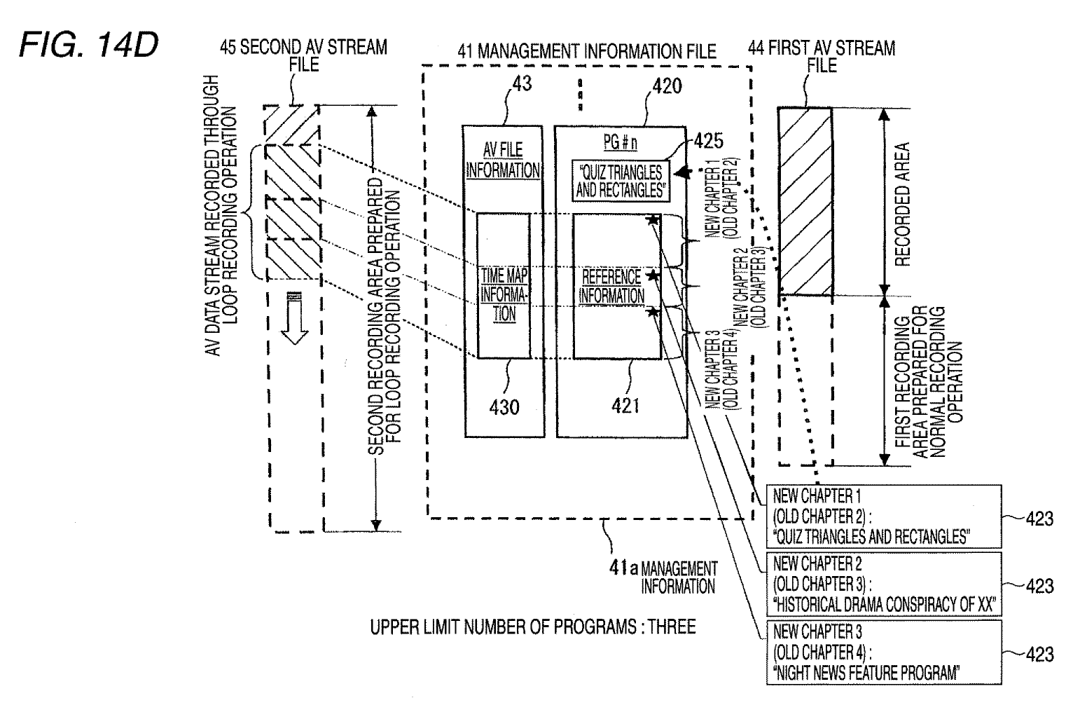

FIG. 14A is a diagram showing a state in which the loop recording operation according to the first modification is started, and FIGS. 14B to 14D are diagrams showing a state in which the loop recording operation according to the first modification progresses. Description will be given to the case in which the modification is applied to the loop recording operation based on the first embodiment.

FIG. 14A schematically shows a subsequent execution of the loop record processing and an operation for setting the name of the contents with the state in FIG. 5 set to be an initial state. The processing of storing the contents in the end of the loop recording operation is not shown. As described above, there is assumed a mechanism for retaining the management information 41a on the internal memory (the work RAM 38) during the execution of the recording operation and recording the management information 41a in the management information file 41 in a recording end timing. Although the number of chapters (the number of programs) in the contents has an upper limit of three in the modification, moreover, this is not limited.

First, FIG. 14A shows a state in which the loop recording operation is started for the second AV stream file 45. Herein, the contents are recorded as PG#n and the AV data stream 400 is started to be recorded from the head of the second AV stream file 45. Although the number of the chapters (the number of the programs) in the contents which is preset through an initialization is set to have an upper limit of three, the number of the chapters in the contents has not reached the upper limit after the start of the loop recording operation in the state of FIG. 14A.

In the state of FIG. 14A, the management information managing section 151 sets a program name acquired from a program information to be used in a display of an EPG screen at the start of the loop recording operation to both the name of the contents and the name of the chapter 422.

In a subsequent state of FIG. 14B, the management information managing section 151 detects a break of a program based on the program information to be used in the display of the EPG screen and sets a new chapter boundary information 423 in a position of the break. In addition, a program name is acquired from the program information to be used in the display of the EPG screen and is set to be a name of a new chapter 422 using a position of the newly set chapter boundary information 423 as a start point.

FIG. 14C shows a state in which the loop recording operation for the second AV stream file 45 further progresses. The operation for recording the AV data stream 400 in the second AV stream file 45 further progresses to bring a state in which three chapters 422 are present in the contents. FIG. 14C shows a state in which a program recording operation corresponding to a third chapter 422 is progressing.

Finally, FIG. 14D shows a state in which the loop recording operation further progresses. With the further progress of the loop recording operation, the number of the chapters in the contents exceeds the preset upper limit, that is, three. Therefore, the chapter 422 positioned on a head in the contents at time of the start of the recording operation disappears and the chapter 422 positioned in a second place (“Quiz Triangles and Rectangles” shown in FIG. 14D) is newly set to be a head chapter in the contents. Consequently, a name of contents to which the same name as the disappearing chapter 422 (“Children's Animation Theater” shown in FIG. 14C) is set is rewritten by copying the name of the chapter 422 (“Quiz Triangles and Rectangles” shown in FIG. 14D) which is newly set to be the head chapter in the contents.

According to the first modification, the name of the program corresponding to the head chapter in the contents is always set to be the name of the contents recorded through the loop recording operation. Consequently, a name of a program which has not been present in the contents is not continuously left as the name of the contents, and there is brought a state in which a consistency of the recorded contents with the name of the contents is taken.

Referring to the second and third embodiments described above, in the same manner as in the first modification of the first embodiment, it is possible to implement a first modification in which the invention is performed through the loop recording operation based on the number of programs.

Second Modification

In the first, second and third embodiments and the first modification, the name of any of the chapters 422 to be the partial areas in the contents which is positioned on the head, is positioned in the rearmost part or has the longest time length is copied to be the name of the contents. In addition to the basic configuration, in the case in which the chapter 422 applying to certain special conditions specified separately by a user is present, it is also possible to propose a configuration including an exceptional processing of preferentially setting the name of the chapter 422 applying to the same special conditions to be the name of the contents. Special conditions for executing the exceptional processing can be variously proposed. As an example, the following conditions can be proposed.

(1) The case in which a user previously registers a program genre as a favorite predetermined condition and an application to a program classified into the registered genre is obtained (for example, an animation, sports and a movie) and

(2) the case in which the user previously registers a keyword as the predetermined condition and the registered keyword is included in a program name (for example, “soccer”, “news” and “weather report”. A program name itself may be applied). A second modification including the exceptional processing will be described below.

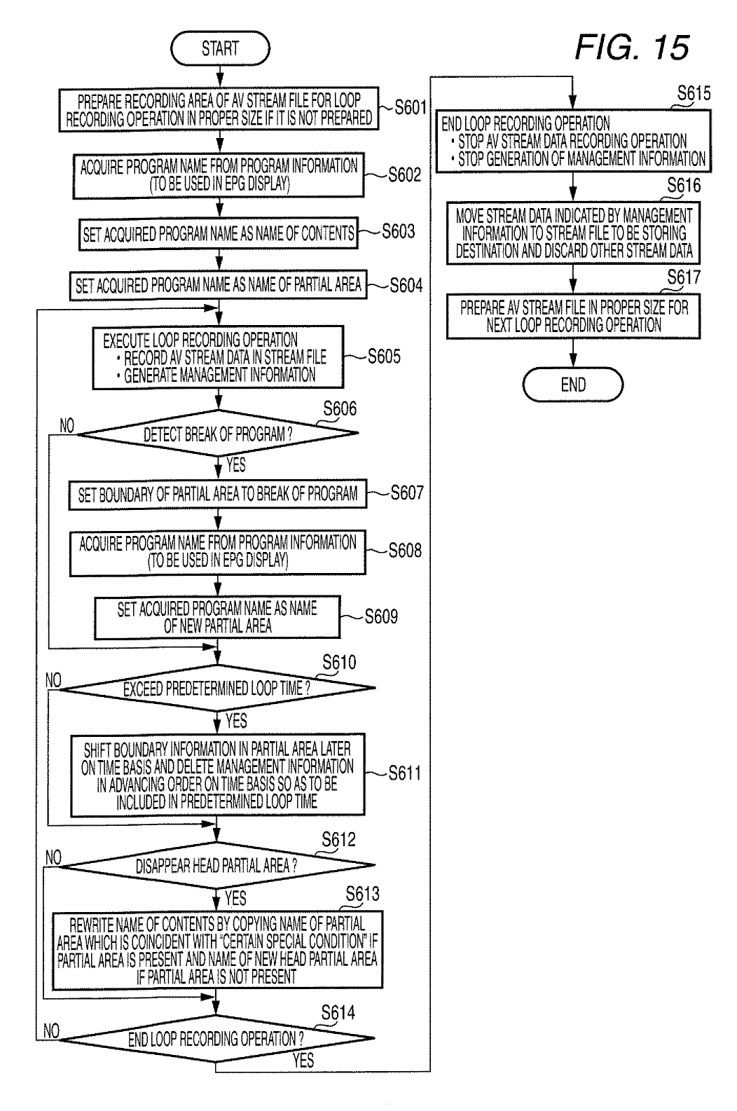

FIG. 15 is a flowchart according to the second modification. FIG. 15 is the flowchart including an exceptional processing of preferentially setting, to the name is of the contents, the name of the chapter 422 applying to a certain special condition specified separately by a user in the contents described in the first embodiment. It is assumed that a special condition for executing the exceptional processing of setting the name of the contents is preset through the user' manipulation prior to the start of the loop recording operation. Based on the example described above, it is assumed that the user previously registers a favorite program genre or a keyword, for instance.

Steps 601 to 612 are performed in the same manner as the steps 101 to 112 according to the first embodiment.

At the step 612, if the head chapter 422 disappears (S612; Yes), the management information managing section 151 rewrites the name of the contents by newly copying the name of the chapter 422 to be a head partial area in the contents in place of the disappearing chapter 422 (S613).

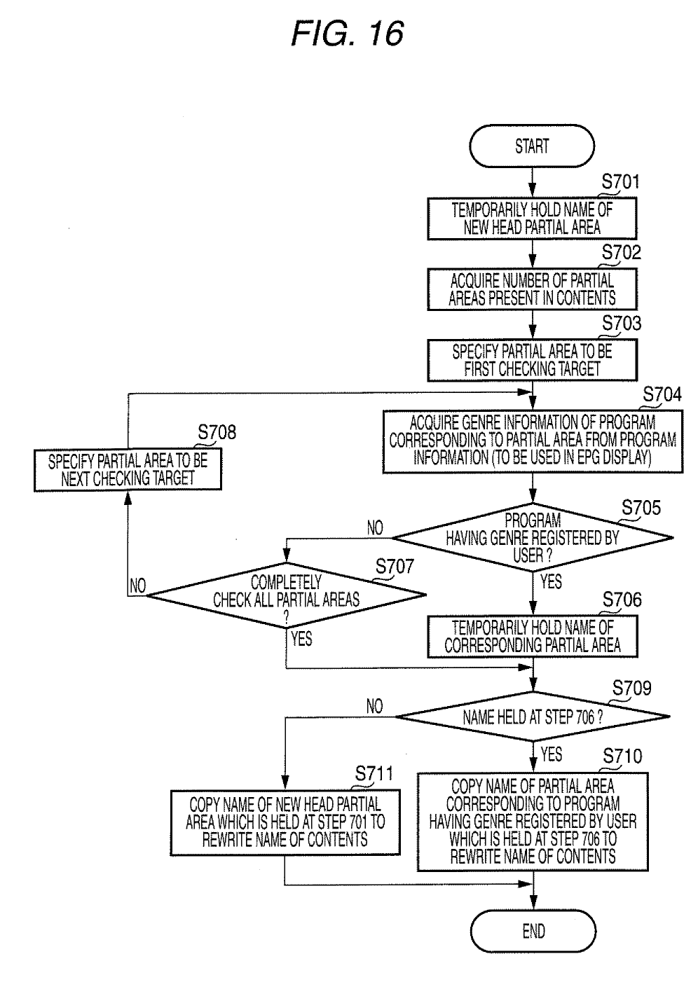

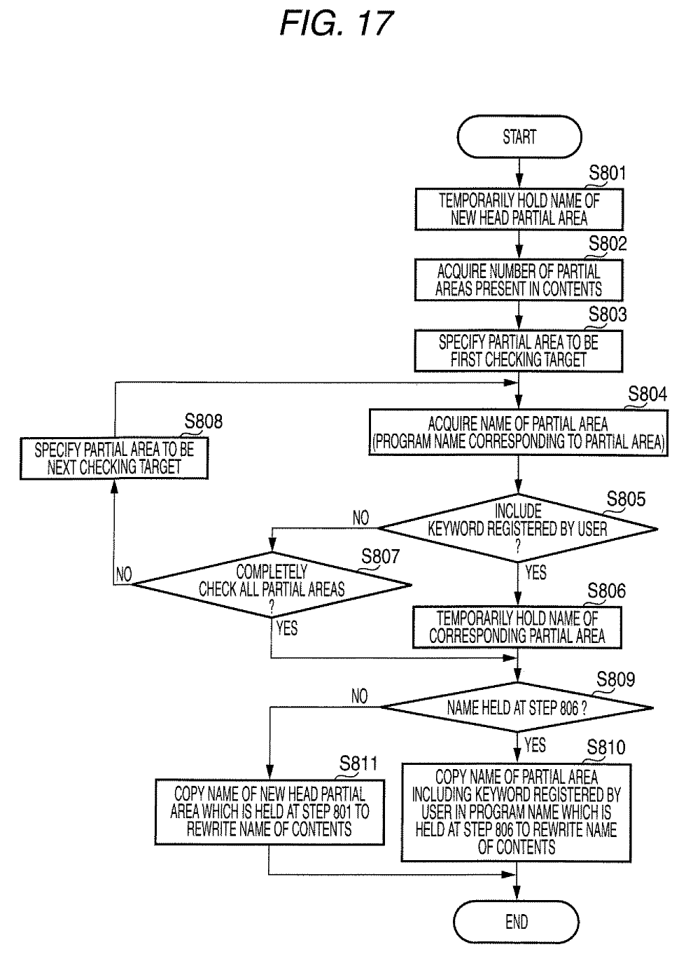

In that case, it is assumed that the name of the chapter 422 which is coincident with a preset special condition is preferentially coped and rewritten as the name of the contents if the same chapter 422 is present in the contents. The processing at the step 613 will be described in accordance with flowcharts shown in FIGS. 16 and 17.

In an example of FIG. 16, whether the classification into the favorite program genre registered previously by the user in one of the examples described above is performed is set to be a special condition for executing the exceptional processing of setting the name of the contents.

At step 701, first, the management information managing section 151 temporarily holds a name of a new head chapter 422 in the contents.

At step 702, next, the management information managing section 151 acquires the number of the chapters 422 to be the partial areas in the contents.

At step 703, subsequently, the management information managing section 151 specifies the chapter 422 to be a first checking target.

At step 704, the management information managing section 151 acquires a genre information of a program corresponding to the chapter 422 to be the checking target from the program information to be used in the display of the EPG screen.

At a next step 705, the management information managing section 151 determines whether the program of which genre information is acquired at the step 704 is a program having a genre registered previously by the user or not, and branches the processing. If the program is classified into the genre registered previously by the user (S705; Yes), the processing proceeds to step 706 in which the name of the corresponding chapter 422 is temporarily held. Then, the acquisition and check of the genre information of the program for the subsequent chapters 422 is skipped to cause the processing to proceed to step 709.

On the other hand, if the program is not classified into the genre registered previously by the user, the management information managing section 151 causes the processing to proceed to step 707. At the step 707, the management information managing section 151 determines whether the acquisition and check of the genre information of the program for all of the chapters 422 included in the contents is completed or not, and branches the processing. If the acquisition and check of the genre information of the program for all of the chapters 422 is not completed (S707; No), the processing proceeds to step 708 in which the chapter 422 to be a next checking target is specified, and the series of processing in and after the step 704 is performed continuously. If the acquisition and check of the genre information of the program for all of the chapters 422 is completed (S707; Yes), the processing proceeds to step 709.

At the step 709, the management information managing section 151 determines whether a name of the program classified into the genre registered previously by the user which is held at the step 706 is present or not, and branches the processing. If the name held at the step 706 is present (S709; Yes), the name of the contents is rewritten by copying the name of the chapter 422 held at the step 706 and corresponding to the program classified into the genre registered previously by the user, and the series of processing is thus ended.

On the other hand, if the name held at the step 706 is not present (S709; No), the management information managing section 151 rewrites the name of the contents by copying a name of a new head chapter 422 in the contents which is held at the step 701, and the series of processing is thus ended.

Another example in the step 613 will be described with reference to a flowchart shown in FIG. 17.

Steps 801 to 803 are the same as the steps 701 to 703.

At step 804, the management information managing section 151 acquires the name of the chapter 422 to be the checking target. This is a name of the program corresponding to the chapter 422.

At a subsequent step 805, the management information managing section 151 determines whether the name (program name) of the chapter 422 acquired at the step 804 includes a keyword registered previously by the user or not, and branches the processing. If the name (program name) of the chapter 422 includes the keyword registered previously by the user (S805; Yes), the processing proceeds to step 806 in which the name of the corresponding chapter 422 is temporarily held. Then, the acquisition and check of the name (program name) of the chapter for the subsequent chapter 422 is skipped to cause the processing to proceed to step 809.

On the other hand, if the name (program name) of the chapter 422 does not include the keyword registered previously by the user (S805; No), the management information managing section 151 causes the processing to proceed to step 807.

At the step 807, the management information managing section 151 determines whether the check of the inclusion of the registered keyword for all of the chapters 422 included in the contents is completed or not, and branches the processing. If the check of the inclusion of the registered keyword for all of the chapters 422 is not completed (S807; No), the processing proceeds to step 808 in which the chapter 422 to be a next checking target is specified, and the series of processing in and after the step 804 is then performed continuously. If the check of the inclusion of the registered keyword for all of the chapters 422 is completed (S807; Yes), the processing proceeds to step 809.

At the step 809, the management information managing section 151 determines whether the name of the program including the keyword registered previously by the user which is held at the step 806 is present or not, and branches the processing. If the name held at the step 806 is present (S809; Yes), the name of the contents is rewritten by copying the name of the chapter 422 including the keyword registered previously by the user which is held at the step 806, and the series of processing is thus ended.

On the other hand, if the name held at the step 806 is not present (S809; No), the management information managing section 151 rewrites the name of the contents by copying a name of a new head chapter in the contents which is held at the step 801, and the series of processing is thus ended.

According to the second modification, the name of the program corresponding to any of the chapters 422 to be the partial areas in the contents which is coincident with the preset specific condition or is positioned on the head of the contents is always set to be the name of the contents recorded through the loop recording operation. Consequently, the name of the program which has not been present in the contents is not continuously left as the name of the contents, and there is brought a state in which a consistency of the recorded contents with the name of the contents is taken.

Referring to the second and third embodiments described above and the first modification of the case in which the invention is performed through the loop recording operation based on the number of programs in place of the time length, in the same manner as in the second modification, it is possible to implement a further modification of the case including such an exceptional processing as to preferentially set, to the name of the contents, the name of the chapter 422 applying to a certain specific condition specified separately by the user.

It is apparent that the present invention is not limited to the embodiments described above, but various configurations can be taken without departing from or changing the technical scope of the present invention.

FIG. 5 shows the example in which the first and second AV stream files 44 and 45 are used and assigned to the normal recording operation and the loop recording operation one by one, and furthermore, the first AV stream file 44 for the normal recording operation is also used as the archive file. On the other hand, as shown in FIG. 2, it is also possible to use the first to third AV stream files 44 to 46, thereby assigning the first and second AV stream files 44 and 45 to the normal recording operation and the loop recording operation one by one respectively, and furthermore, assigning a special archive file for storing the contents to the third AV stream file 46, for example.

In the case in which the special archive file for storing the contents is assigned, the first AV stream file 44 can be devoted to the operation for recording the AV data stream in the normal record processing. If the recording apparatus 10 has a plurality of encoders or tuners, therefore, it is possible to execute the normal recording operation at the same time while executing the loop recording operation. In that case, it is apparent that the following can easily be guessed from the contents described in the invention. More specifically, it is possible to store the contents recorded through the normal recording operation in the archive file without waiting for the end of the loop recording operation or to store the contents recorded through the loop recording operation in the archive file without waiting for the end of the normal recording operation.

Moreover, the present invention is not limited to only the loop recording operation but can also be applied to the normal recording operation. As a method of utilizing the normal recording operation, in recent years, a programmed recording operation which designates start/end dates and times of a record processing, particularly, a programmed recording operation based on a system for performing a selection on a program unit over an EPG screen is a mainstream. However, there is often performed a manual recording operation using a record button/a stop button provided in a body of the recording apparatus 10 or a remote control.

In the case in which the manual recording operation is performed by the user, it is not unusual that a plurality of programs is included in the recorded contents. Differently from the loop recording operation, a part of the recorded contents can be prevented from being deleted in the middle from the start of the normal recording operation to the end thereof in the same recording operation. Therefore, there is not generated an inconsistency of the name of the contents with the contents. However, it is possible to enhance the convenience of the user more greatly by applying the contents according to the second embodiment to set the name of the program recorded most newly on a time basis to the name of the contents or applying the contents according to the third embodiment to set the name of the program having the longest time length to the name of the contents.

Although the first to third embodiments and the first and second modifications have been mainly described as hardware, moreover, it is also possible to provide them as software to be performed by the CPU 31.

What is claimed is:

1. A storage apparatus comprising:
a storage device that stores data on a storage medium being configured with a storage area on which the data having a plurality of partial areas is repetitively overwritten; and
a management unit that operates to:
generate management information for managing the data based on a name assigned to the partial area, boundary information representing a boundary between the partial areas, and time information representing time on which each of the partial areas are stored;
store the management information in the storage device; and
set, as a name of the data, the name of one of the partial areas having the oldest time based on the management information.

2. The apparatus according to claim 1, wherein the management unit sets, as a candidate for the name of the data, the name of an extracted partial area that is extracted from the partial areas based on a condition that is configurable by a user.

3. The apparatus according to claim 2, wherein the management unit sets a genre as the condition.

4. The apparatus according to claim 2, wherein the management unit sets a keyword as the condition.

5. A storage apparatus comprising:
a storage device that stores data on a storage medium being configured with a storage area on which the data having a plurality of partial areas is repetitively overwritten; and
a management unit that operates to:
generate management information for managing the data based on a name assigned to the partial area, boundary information representing a boundary between the partial areas, and time information representing time on which each of the partial areas are stored;
store the management information in the storage device; and
set, as a name of the data, the name of one of the partial areas having the newest time based on the management information.

6. The apparatus according to claim 5, wherein the management unit sets, as a candidate for the name of the data, the name of an extracted partial area that is extracted from the partial areas based on a condition that is configurable by a user.

7. The apparatus according to claim 6, wherein the management unit sets a genre as the condition.

8. The apparatus according to claim 6, wherein the management unit sets a keyword as the condition.

9. A storage apparatus comprising:
a storage device that stores data on a storage medium being configured with a storage area on which the data having a plurality of partial areas is repetitively overwritten; and
a management unit that operates to:
generate management information for managing the data based on a name assigned to the partial area, boundary information representing a boundary between the partial areas, and time information representing time on which each of the partial areas are stored;
store the management information in the storage device; and
set, as a name of the data, the name of one of the partial areas having the longest time based on the management information.

10. The apparatus according to claim 9, wherein the management unit acquires program information from a server connected to the apparatus and calculates a time length of each of the partial areas based on the program information.

11. The apparatus according to claim 9, wherein the management unit sets, as a candidate for the name of the data, the name of an extracted partial area that is extracted from the partial areas based on a condition that is configurable by a user.

12. The apparatus according to claim 9, wherein the management unit sets a genre as the condition.

13. The apparatus according to claim 9, wherein the management unit sets a keyword as the condition.

14. A method for storing data, the method comprising:
storing the data on a storage medium being configured with a storage area on which the data having a plurality of partial areas is repetitively overwritten;
generating management information for managing the data based on a name assigned to the partial area, boundary information representing a boundary between the partial areas, and time information representing time on which each of the partial areas are stored;
storing the management information in the storage device; and
setting, as a name of the data, the name of one of the partial areas having the oldest time based on the management information.
